(19) United States
(12) Patent Application Publication
(10) Pub. No.: US 2014/0164042 A1
(43) Pub. Date: Jun. 12, 2014

(54) NETWORK-BASED SCHEDULING APPLICATION

(71) Applicants: Chad Halvorson, Oakdale, MN (US); Daniel Olfelt, St. Paul, MN (US); Garret Voight, White Bear Lake, MN (US)

(72) Inventors: Chad Halvorson, Oakdale, MN (US); Daniel Olfelt, St. Paul, MN (US); Garret Voight, White Bear Lake, MN (US)

(21) Appl. No.: 14/103,045

(22) Filed: Dec. 11, 2013

Related U.S. Application Data
(60) Provisional application No. 61/735,794, filed on Dec. 11, 2012.

(51) Int. Cl. G06Q 10/06

(52) U.S. Cl. CPC G06Q 10/06313
USPC 705/7.17

(57) ABSTRACT

A computer program or application for scheduling shift employees. The program is network-based, preferably we-based and utilizes any or all of mobile devices (e.g., Smart Phones or tablets), social media, email and text messages to communicate the schedule to the employee. The program provides the employer with easy schedule organization and an easy tool for collaboration and communication with the employee. The program provides the employee with an ability to monitor, access and acknowledge the schedule, and even alter the schedule, pending approval from the employer.

### CROSS-REFERENCE TO RELATED APPLICATIONS

This application claims the benefit of U.S. Provisional Patent Application No. 61/735,794, filed Dec. 11, 2012 and titled “CLOUD-BASED SCHEDULING APPLICATION” which application is incorporated herein by reference in its entirety.

### TECHNICAL FIELD

The present disclosure is directed to an electronic scheduling application or program, for assigning work shifts to employees.

### BACKGROUND

Scheduling by an employer of employees of multiple duties and multiple shifts requires the coordination of individuals with different levels of qualifications. Many businesses require employees to have standard work schedules week after week and do not require flexible scheduling. However, many other businesses require the variable assignment of employees with job shifts that change from week to week.

Employers or managers typically have the responsibility of assigning employees with shifts according to the employer needs. Moreover, this responsibility also must take into account employee availability based upon full time vs. part time status, hours to be worked per week, and vacation or other leave requests. A manager's ability to set out the schedule is thus largely dependent on the information he/she has at hand regarding both the employer's needs and the employees availability. Also, for most businesses, various level of job duties are required to be scheduled for each time period as well. The scheduling task is exacerbated by the number of employees, the number of shifts to be filled, the qualifications for employees with respect to the shifts that are to be filled, hours to be worked by select employees, and the availability issues of the employees.

With today's electronic capabilities, the hand written or paper work schedule is obsolete. Electronic applications have been developed to facilitate scheduling by a manager or employer based upon the given information that the manager has access to within such an application. It is however difficult to include flexibility to both an employer or manager and the employees with respect to being notified of a schedule, schedule changes, and an employees ability to be involved within the process of scheduling.

### SUMMARY

The present invention is directed to a computer program or application for scheduling and communicating to shift employees. The program provides the employer with easy schedule organization and an easy tool for collaboration and communication with the employee. The user interface is easy to use by both the employer and the employee, is basic and logical, and provides an uncomplicated scheduling experience, allowing simple “click and drag” shift assignment. Additionally, the program has an intelligence factor, providing scheduling options based on assumptions derived from previous decisions by the user. The program is preferably cloud-based and can utilize any or all of mobile devices (e.g., Smart Phones, tablets such as “Kindle™” and “iPad™”), social media, email and text messages to communicate the schedule to the employee. The program provides the employee with an ability to monitor, access and acknowledge the schedule, and even alter the schedule, pending approval from the employer.

The program preferably provides uninterrupted mobile communication between the employer and employee, which facilitates efficient scheduling. The various preferred features of the program provide easy interaction among and between the employer and the employee(s).

One particular embodiment of the present invention is a network-based mobile scheduling program that allows an employer to set a work schedule, and then it automatically sends notification to an employee via email, text message and/or mobile device regarding the schedule. In some embodiments, the program is configured to receive a reply from the employee regarding the schedule, any reply being able to be sent by, for example, email, text message, and/or mobile device such as a Smart Phone or a tablet. In further embodiments, the program is configured to respond to the reply sent by the employee.

Another particular embodiment of the present invention is a network-based computer program that has a shift scheduling feature that allows an employer to input employee qualifications, allows an employer to input pre-qualifications for a shift, and allows an employer to create a schedule by assigning qualified employees to shift(s). The program can be configured to not accept a non-qualified employee to a pre-qualified shift, and to suggest an employee to a non-pre-qualified shift. The program may be configured to notify the employee via mobile device, email and/or text message about their assigned shift(s), and/or to allow the employee to view the assigned shift(s) on a mobile device. In some embodiments, the shift scheduling feature of the program also allows an employee to decline or request a trade of an assigned shift via mobile device, email, and/or text message, and allows an employer to override a trade request. In some embodiments, the shift scheduling feature further allows the employer to notify the employee of an available shift, and allows the employee to accept or reject the available shift, of which the employer may be advised. The program may be further configured to track total hours assigned to an employee in a schedule, and to indicate when a predetermined number of hours is exceeded. The program may allow the employer to input employee hourly wage, and if the predetermined number of hours is exceeded, calculates payroll expenses for the exceeded hours.

The software application or program of the present invention simplifies employee scheduling and communication by using an innovative blend of collaborative communication technologies, including the web, mobile apps, text messaging, social media, and email. The program's simple interface and intelligent communication platform saves time and money while reducing absenteeism and improving employee accountability.

These and various other features and advantages will be apparent from a reading of the following detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention may be more completely understood in consideration of the following detailed description of various embodiments of the invention in connection with the accompanying drawing, in which:

FIG. 1 is a screen shot of a scheduling program of the present invention showing a login screen for any user, employer or employee, to gain access to the program of the present invention;

FIG. 2 is a screen shot of a scheduling program of the present invention showing a dashboard screen for a particular user by which a user can access that user particular schedule, a scheduler function of the program, make requests, and control options of the program;

FIG. 3 is a screen shot of a scheduling program of the present invention showing a scheduler function as available for a user to assign specific shifts by position and time to employees;

FIG. 4 is a screen shot of a scheduling program of the present invention similar to FIG. 3 and further showing the assignment of additional shifts to certain employees along with the changing of a shift from one employee to another;

FIG. 5 is a screen shot of a scheduling program of the present invention showing the scheduler function as in the process of clearing to set up for a new schedule;

FIG. 6 is a screen shot of a scheduling program of the present invention showing a user ready to set up a new schedule with availability of certain employees indicated;

FIG. 7 is a screen shot of a scheduling program of the present invention showing the scheduling function with employee preferences indicated by corner tabs;

FIG. 8 is a screen shot of a scheduling program of the present invention similar to FIG. 7 showing a green tab as indicating a shift leader position preference;

FIG. 9 is a screen shot of a scheduling program of the present invention showing a scheduling of a supervisor to a certain shift;

FIG. 10 is a screen shot of a scheduling program of the present invention showing a scheduling of a manager function added to multiple employees on various days;

FIG. 11 is a screen shot of a scheduling program of the present invention showing the scheduling function with a publishing function for notification to employees;

FIG. 12 is a screen shot of a scheduling program of the present invention showing a publishing widget that can provide choices of options for publishing a schedule;

FIG. 13 is a screen shot of a scheduling program of the present invention similar to FIG. 12 with a note showing a messaging function along with publication;

FIG. 14 is a screen shot of a scheduling program of the present invention showing the scheduling function along with a replacement feature;

FIG. 15 is a screen shot of a scheduling program of the present invention showing the result of clicking on the replacement feature and indicating suitable employees that qualify for taking the shift based upon program evaluation of qualification requirements for the shift;

FIG. 16 is a screen shot of a scheduling program of the present invention showing a message provided within a message box to be sent to qualified employees for the replacement function in order to find a replacement for the chosen shift;

FIG. 17 is a screen shot of a scheduling program of the present invention showing the scheduling function as usable by an employee from which an employee can access a my schedule function;

FIG. 18 is a screen shot of a scheduling program of the present invention showing an employee's schedule as accessed from the screen of FIG. 17;

FIG. 19 is a screen shot of a scheduling program of the present invention showing details of a chosen schedule from the screen of FIG. 18;

FIG. 20 is a screen shot of a scheduling program of the present invention showing an employee's election for a shift swap from the screen of FIG. 19;

FIG. 21 is a screen shot of a scheduling program of the present invention similar to FIG. 20 showing the addition of a message as can be sent to other employees regarding a potential shift swap by one employee;

FIG. 22 is a screen shot of a scheduling program of the present invention similar to FIG. 20 showing a confirmation of a request being made for a shift swap;

FIG. 23 is a screen shot of a scheduling program of the present invention showing the scheduler mode with a feature for indicating hour information per employee as to hours worked and maximum hours;

FIG. 24 is a screen shot of a scheduling program of the present invention showing an indication of a maximum of hour being exceeded by a color variation of the hour information;

FIG. 25 is a screen shot of a scheduling program of the present invention showing the screen as in FIG. 24 with a change from an hour indication to a money or value indication by employee;

FIG. 26 is a screen shot of a scheduling program of the present invention showing a screen similar to FIG. 25 with a value indication for an employee;

FIG. 27 is a screen shot of a scheduling program of the present invention showing a cumulative valuation button and number on the screen;

FIG. 28 is a screen shot of a scheduling program of the present invention similar to FIG. 27 but with only a supervisor box ticked so that the information provided within the screen is limited to the supervisor role;

FIG. 29 is a screen shot of a scheduling program of the present invention similar to FIG. 28, but with the shift leader box ticked instead of the supervisor box;

FIG. 30 is a screen shot of a scheduling program of the present invention similar to FIG. 29 showing a function of changing the value indication back to an hour indication;

FIG. 31 is a screen shot of a scheduling program of the present invention showing

FIG. 32 is a screen shot of a scheduling program of the present invention showing the scheduler function for an employee to see shifts that are qualified for by that employee for that day;

FIG. 33 is a screen shot of a scheduling program of the present invention showing a supervisor filter box ticked to show only supervisor shifts and the employees that are qualified for the shift in question;

FIG. 34 is a screen shot of a scheduling program of the present invention similar to FIG. 33 with a selection being made as to the filling of a supervisor shift from a selection box as in FIG. 33;

FIGS. 35 and 36 are screen shots of a scheduling program of the present invention similar to FIG. 33 showing those employees that are qualified for a selected shift with the supervisor filter box ticked so that an employer can identify employees that are qualified for a supervisor shift but that have other shifts assigned in other positions;

FIG. 37 is a screen shot of a scheduling program of the present invention similar to FIGS. 35 and 36 indicating a toggle button for filtering or consolidating the view based upon selected positions;

FIG. 38 is a screen shot of a scheduling program of the present invention similar to FIG. 37 showing employees that are qualified as a supervisor;

FIG. 39 is a screen shot of a scheduling program of the present invention similar to FIG. 38 but with grayed out indications of other inactive employees within the system;

FIG. 40 is a screen shot of a scheduling program of the present invention showing the main scheduler page with a colored line at the top of the schedule for the employer for designation of open shifts;

FIG. 41 is a screen shot of a scheduling program of the present invention similar to FIG. 40 with a day selected by a employer manager to shown in a box available shifts that can be selected to designate as open shifts;

FIG. 42 is a screen shot of a scheduling program of the present invention similar to FIG. 41 showing plural shifts that are noted as open;

FIG. 43 is a screen shot of a scheduling program of the present invention similar to FIG. 42, but also showing the available shifts being published by way of a publication button;

FIG. 44 is a screen shot of a scheduling program of the present invention similar to FIG. 43 but after the available shifts are published as open;

FIG. 45 is a screen shot of a scheduling program of the present invention similar to FIG. 44 showing an employers ability to directly assign an employee to a selected shift;

FIG. 46 is a screen shot of a scheduling program of the present invention similar to FIG. 45 showing a box including those employees from which the employer can select to assign an employee by the assign button;

FIG. 47 is a screen shot of a scheduling program of the present invention similar to FIG. 46 but showing the removal of plural employees from those that can elect a selected shift by unticking boxes related to those employees;

FIGS. 48 and 40 are screen shots of a scheduling program of the present invention showing the selection of a notification function for adding a personalized note to the eligible employees;

FIGS. 50 and 51 are screen shots of a scheduling program of the present invention similar to FIG. 49 showing a confirmation that a notification has been sent and the further ability to assign an employee to the selected shift; and

FIG. 52 is a screen shot of a scheduling program of the present invention showing a control ability to change representative colors as they are assigned for shifts by certain shift qualifications.

### DETAILED DESCRIPTION OF THE INVENTION

The present disclosure is directed to a network-based scheduling program that provides easy and efficient collaboration and communication between an employer and employee(s) via a private network, a web browser or an Internet enabled mobile device(s). The easy to use, uncomplicated and logical user interface allows an employer to quickly and easily create a schedule, filling shifts with available and qualified personnel. The program allows the employee to interact with the schedule, by on-line accepting and declining shifts, and trading shifts, thus providing a sense of ownership for the employee. For both the employer and the employee, the scheduling program is user-friendly, easy to navigate, and easy to use.

In the following description, reference is made to the accompanying figures that form a part hereof and in which are shown by way of illustration at least one specific embodiment. It is to be understood that other embodiments are contemplated and may be made without departing from the scope or spirit of the present invention. The following detailed description, therefore, is not to be taken in a limiting sense. While the present invention is not so limited, an appreciation of various aspects of the invention will be gained through a discussion of the example provided below.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein, “employer” is a person or persons responsible for scheduling the workers or otherwise filling the needed shifts; it is not necessary that the “employer” is the business owner, but may be, for example, a manager or supervisor who has responsibility for staffing. The “employee” or “worker” is one who is slated to work. In some embodiments, an “employer” may also be an “employee”. The term “user”, as used herein, refers to the person using the scheduling program, either the employer or an employee.

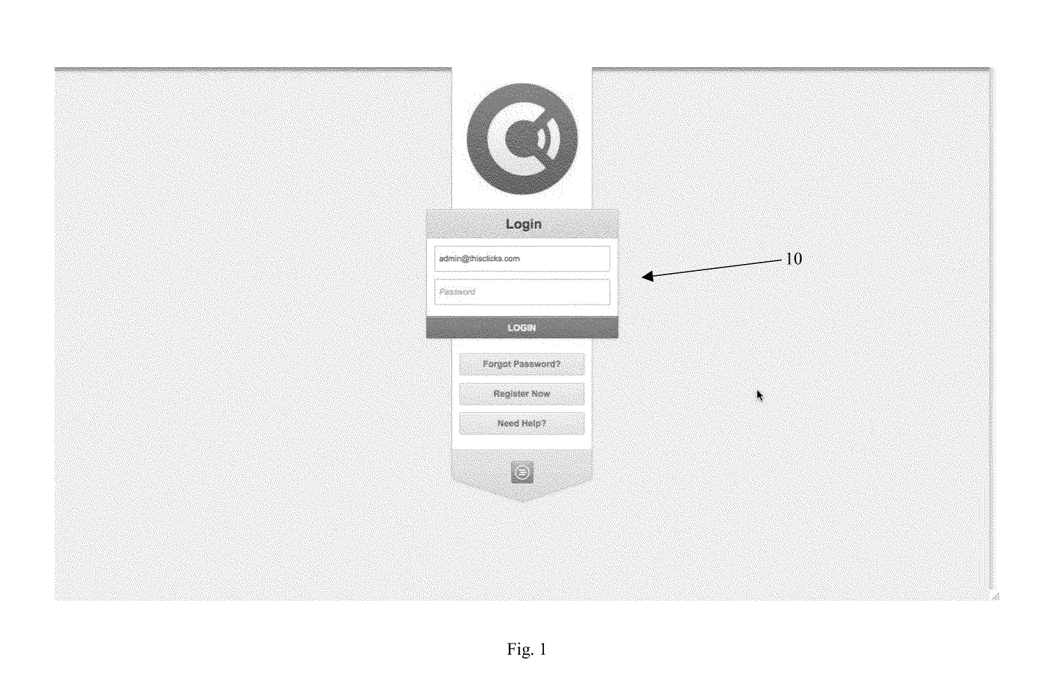

The program of the present disclosure is preferably network-based and more preferably web-based, in that it operates through an application or a web browser or Internet enabled mobile device. The program may be server-based or cloud-based, depending on the manner by which data is stored for use by the program. Each employer preferably has its own unique URL or web address so that all employees and the employer can use that web address to log into the same page. FIG. 1 illustrates a log-in screen 10 for a program of the present invention. The employer can customize the graphics for the log-in page, such as with the company's logo. Each user (i.e., employer or employee) will preferably have a unique log-in password. The program has several preferable features that allow the user to easily manage work shifts, an overall schedule, and handle other employee concerns. The program preferably also has a communication feature that efficiently disseminates the work schedule to employees via Internet enabled devices and provides for two-way communication between the employees and the program.

The program of the present invention comprises application software that is stored within memory of a computer or server device that includes one or more microprocessors for operating the program according to set commands and based upon input from users as described below with respect to aspects of the present invention. Thus, the present invention is directed to a computer program product that comprises a tangible computer readable recordable storage medium that includes computer useable program code. In particular, the computer usable program code is for scheduling employees for any number, but preferably a plurality, of work shifts that have different levels of qualifications. The computer useable program code preferably allows for an employer to set a work schedule and automatically send notification to an employee via email, text message and/or mobile device regarding the schedule.

Systems of the present invention include any computer based or server based system that allows electronic communication over a private network, a public network, or both public and private type networks from one or more additional computers or other electronic devices to a computer or server having the program or application software of the present invention loaded and installed to operate thereon. A private network can include an application server having the application software of the present invention stored within memory thereof so as to be operable thereon, as such software installation is well understood in the art. Such a network can communicate between the application server and any number of other computers or electronic devices like smart phones, tablets, and the like by way of a wired or wireless communication network. Typically, a private network is limited by access to only select users as may be controlled at the server level.

A public network can include any public network, such as the Internet allowing access to the public whether limited by a controlled access by subscription or otherwise or not. Typically, a website is assigned to a URL or address to which users can communicate with the website via the Internet. Access is preferably controlled by a username and password.

The present invention is directed to a network-based application or program that would be installed on a computer or application server to which users have controlled access over a private network, a public network, or a combination of public and private networks. Preferably, the present invention is directed to a web-based application, meaning that the application software or program is stored within memory of an application server to which access is made over at least partially over a public network such as the Internet. Most preferably, the present invention is directed to a cloud-based application meaning that the application software or program is stored within memory of an application server that is accessible over at least partially a public network such as the Internet and wherein the application server utilizes a system of data storage servers as may be set up around the world for the purpose of creating a “cloud” data storage system to which the application server with the program of the present invention has electronic access to the stored data within the cloud.

Moreover, aspects of the present invention preferably include communication by users with the application server in both directions at least partially by way of other electronic communications, such as including wireless, wired, or mobile phone technology. Communication may include the use of phones or smart phone devices by way of a data transfer including the use of the Internet as well as including SMS or text messaging technology as in also well understood in the art. An application server under the control of a user by way of the Internet or otherwise can preferably also communicate with other users by way of the Internet, such as by email, or by a phone system, such as by way of SMS text messaging as such web-based functionality is well known as well in the art.

The program overall, can maintain a list of all employees, know their qualifications for certain shift positions, for example, for a manger shift, supervisor shift, shift leader, etc., and optionally can follow an employee's pay, based on their hourly wage. The can program monitor the number of employees, and of which position, is needed for each shift. All this information can be uploaded into the program by the user at initial set-up of the program. Based on this information and from previous shift schedules, the program can intelligently suggest scheduling options, simplifying the scheduling task for the user.

Dashboard

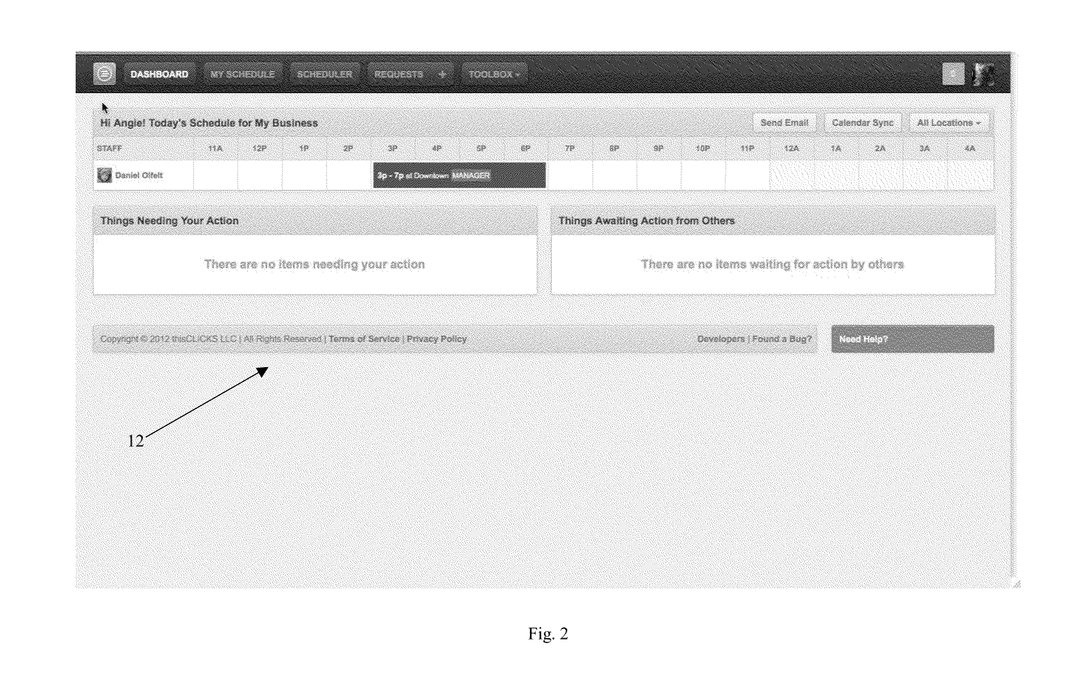

After logging in, a user may be automatically taken to a dashboard 12, as shown in FIG. 2, if the program is thus set-up. Alternately, a button may be clicked to access the dashboard. The dashboard can provide a summary view of the current status quo (e.g., what's going on, what needs to be dealt with and take care of things relating to the schedule

At the top as illustrated, the dashboard can give the user a snapshot of the schedule as it currently affects the user. The illustrated screen shot shows the schedule from now into 12 hours in the future as an example. In FIG. 2, it is seen that only one employee (Daniel Olfelt) is scheduled to work from 3 pm to 7 pm, at the downtown location. If additional employees were also scheduled to work within the next 12 hours, those could also be shown.

Still referring to FIG. 2, below the scheduled employees, are different elements that require action by the user. These fields are specifically directed to the logged-in user. In FIG. 2, there are no items in “Things Needing Your Action”; examples of items that would be listed include approving requests from employees for time-off, for shift changes, etc. There are also no items in “Things Awaiting Action from Others”; items that might be listed here include actions needing to be done by others (either employees or other employer), but which the logged-in user might want to be aware of

Scheduling

The Scheduler tool is an easy-to-use and easy-to-learn tool that allows a user to view the entire week's schedule, and move shifts easily from person-to-person, day-to-day, until the user is completely satisfied with the schedule. A user can save scheduled templates, which make it easier to get a schedule started and finished. The scheduling feature of the program is preferably configured to provide intelligent assumptions regarding scheduling of employees. Based on which employee is available and qualified to work a particular shift, as well as various options such as previous schedules, the program can make various assumptions and can thus recommend scheduling options for a user, thus simplifying the user's scheduling feat. The scheduling features can also provide an uninterrupted communication component between an employer and its employees.

The scheduling feature (i.e., the Scheduler) can be accessed by clicking a button preferably provided at the top of each screen. The scheduling feature is the largest portion of the program, allowing schedule creation that is easy and fast for the employer. The scheduling feature preferably functions with a “click and drag and drop” format, allowing employees and shifts to be matched, changed, rearranged, and otherwise configured.

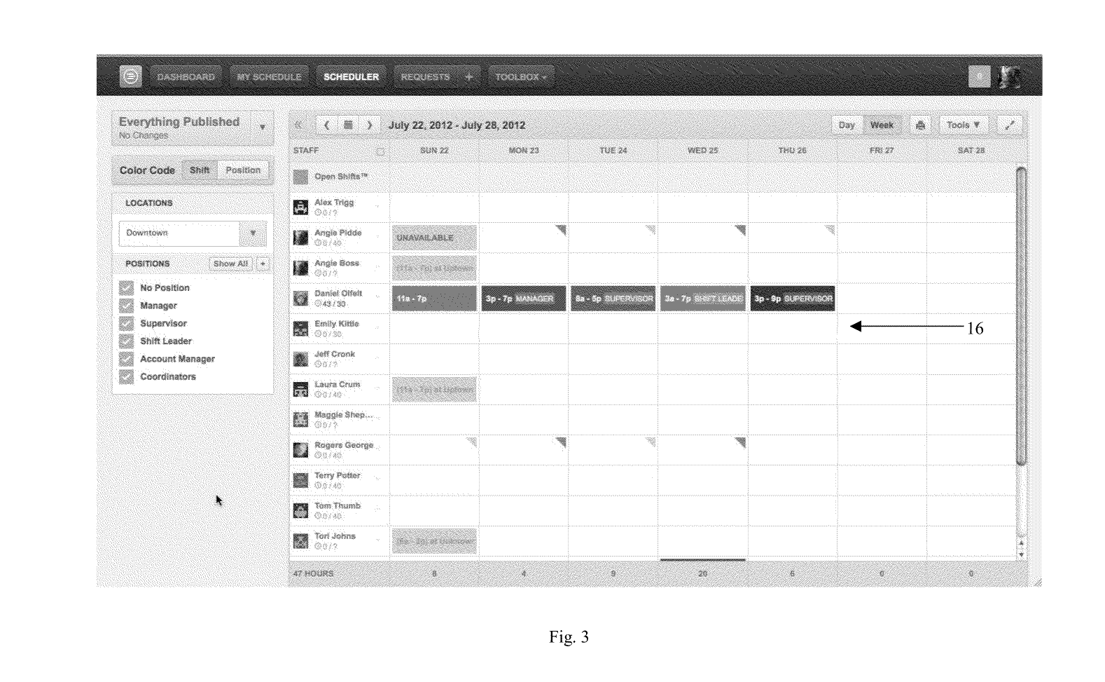

See for example, FIG. 3 at region 16, which shows employee Daniel Olfelt scheduled to work Sunday from 11 am to 7 pm, Monday from 3 pm to 7 pm as “manager”, Tuesday 8 am to 5 pm as “supervisor”, Wednesday 3 am to 7 pm as “shift leader”, and Thursday 3 pm to 9 pm as “supervisor”.

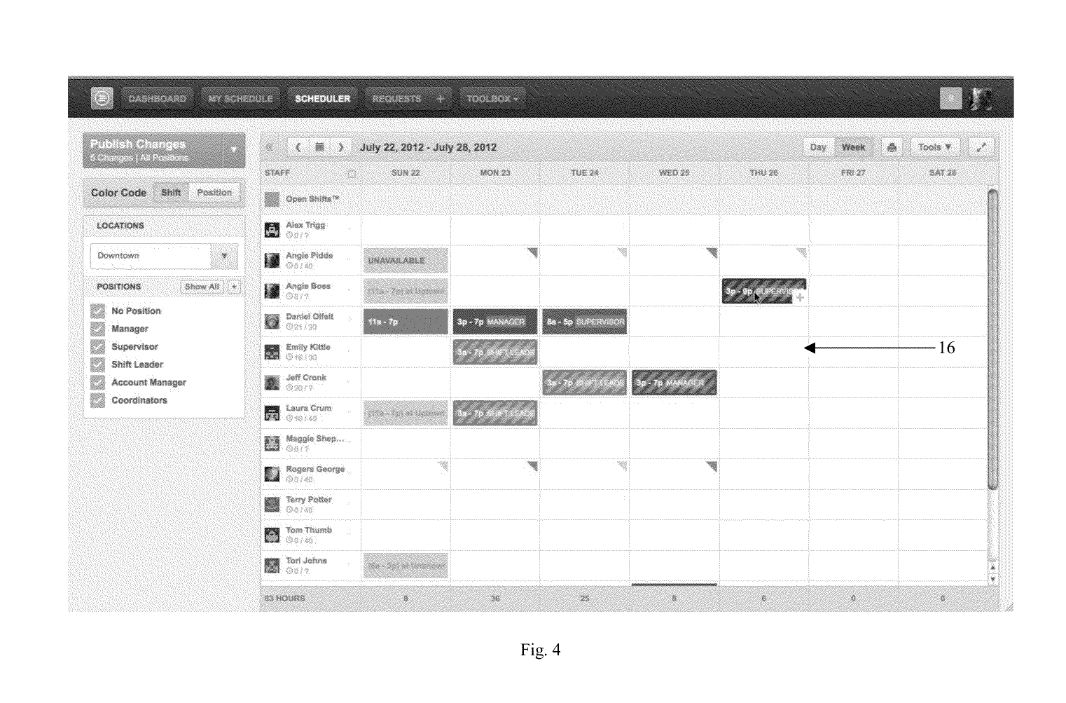

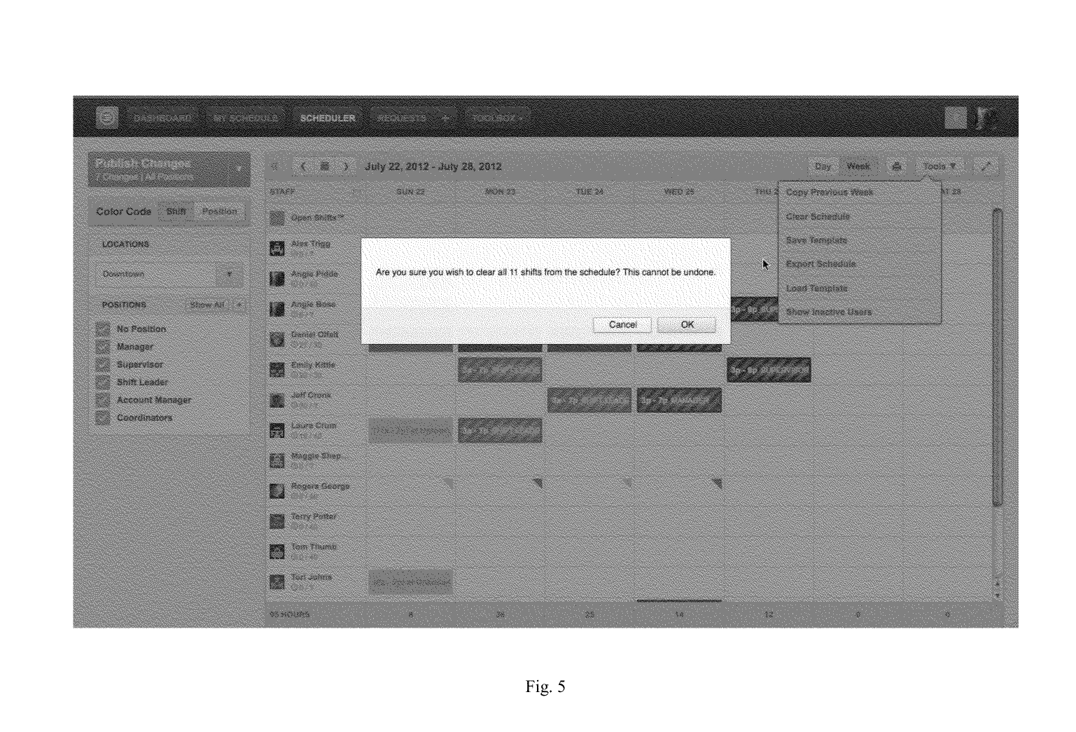

To add a “shift leader” to Monday and Tuesday for example, the user can click on Daniel's “shift leader” shift on Wednesday, copy and paste it (e.g., by using the “ctrl” key as well known for copy & paste) to a location corresponding to an employee for Monday and for Tuesday. See, for example, FIG. 4, where “shift leader” shifts were assigned to Emily Kittie and Laura Crum on Monday and to Jeff Cronk on Tuesday. To change the “supervisor” shift on Thursday from Daniel (FIG. 3) to Angie Boss the user can click and drag the “supervisor” shift from one to the other.

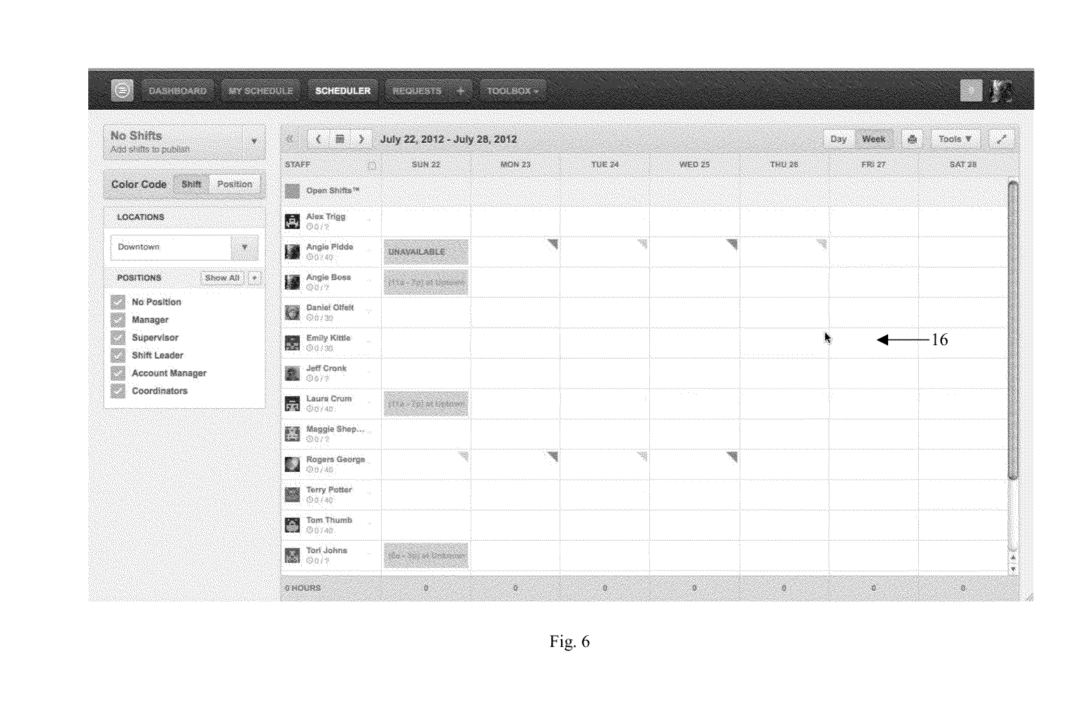

To begin a new schedule, the schedule can for example as in FIG. 4 be cleared (FIG. 5) to see all of the availability options that have been set by employees. For example, Angie Boss, Laura Crum and Tori Johns have indicated their availability to work on Sunday, but are not assigned a shift. Also, Angie Pidde is indicated on the screen as not available any time on Sunday (FIG. 6). With this information, the user (e.g., employer) is able to easily set the schedule because the program can alert the user when an employee is unavailable. This is a convenience to both the employee and employer.

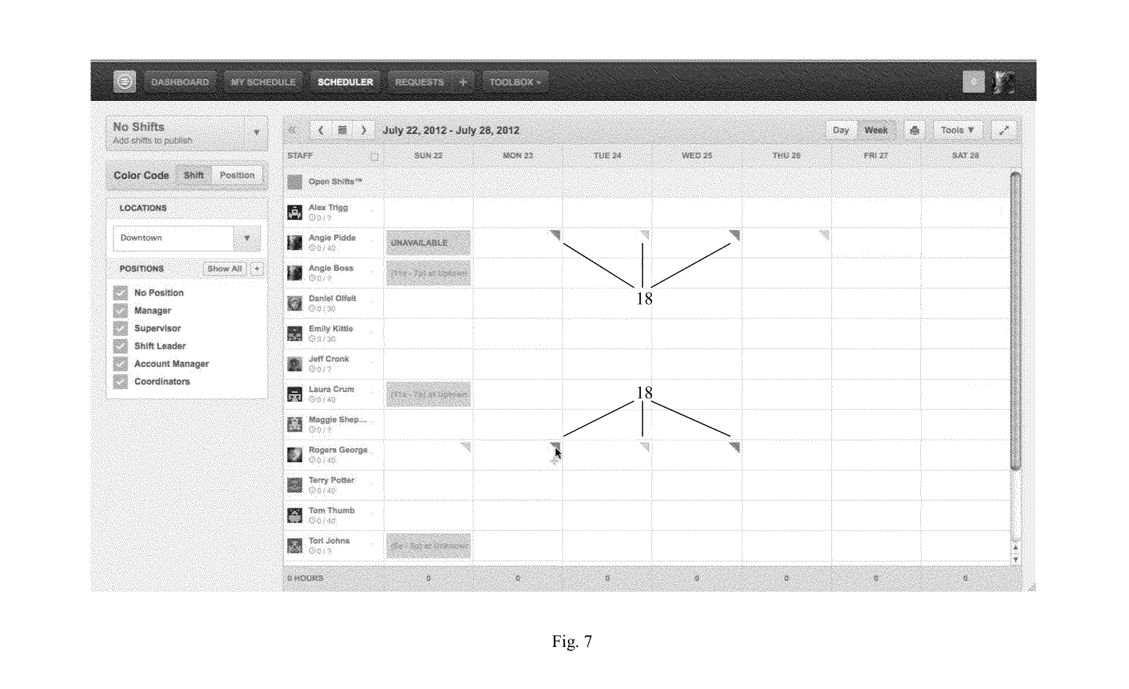

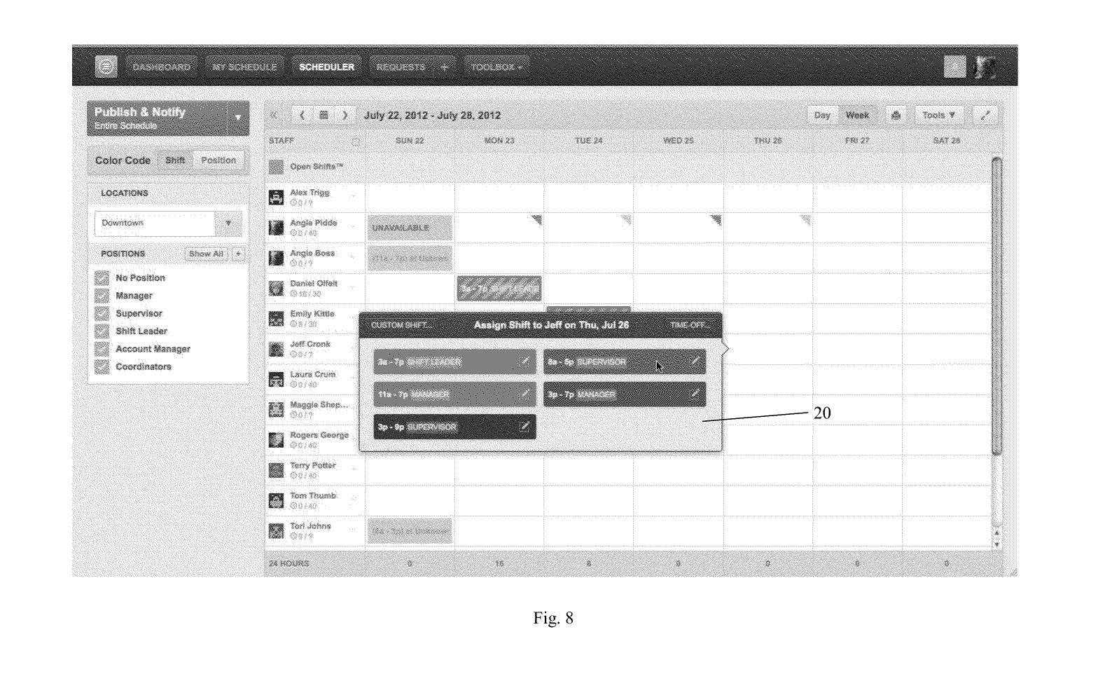

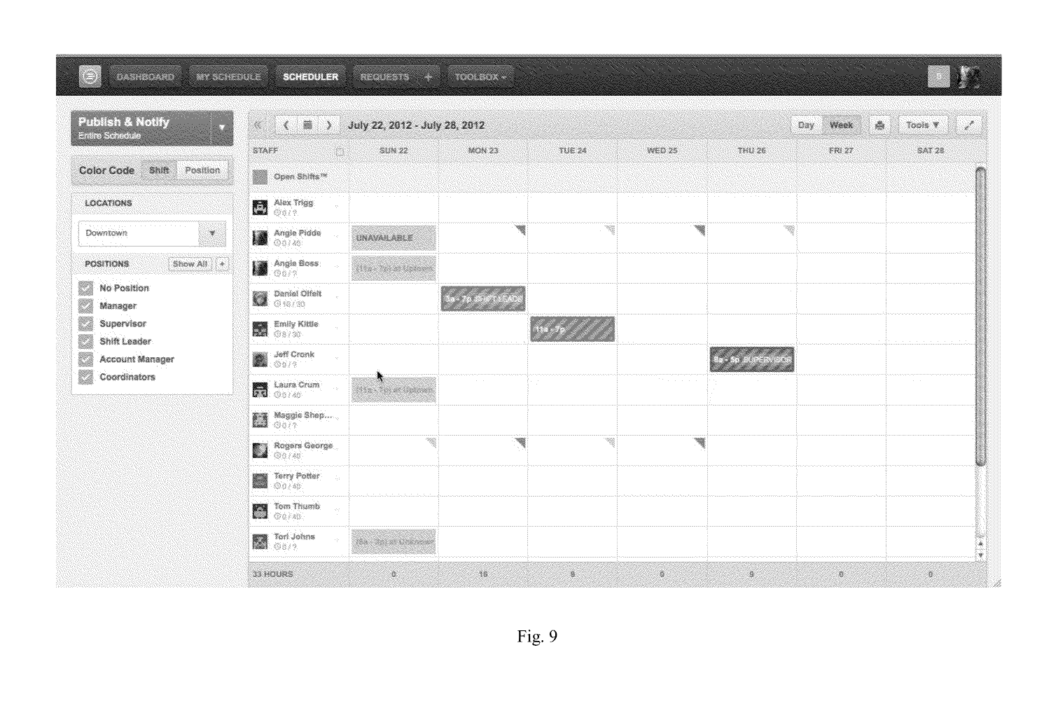

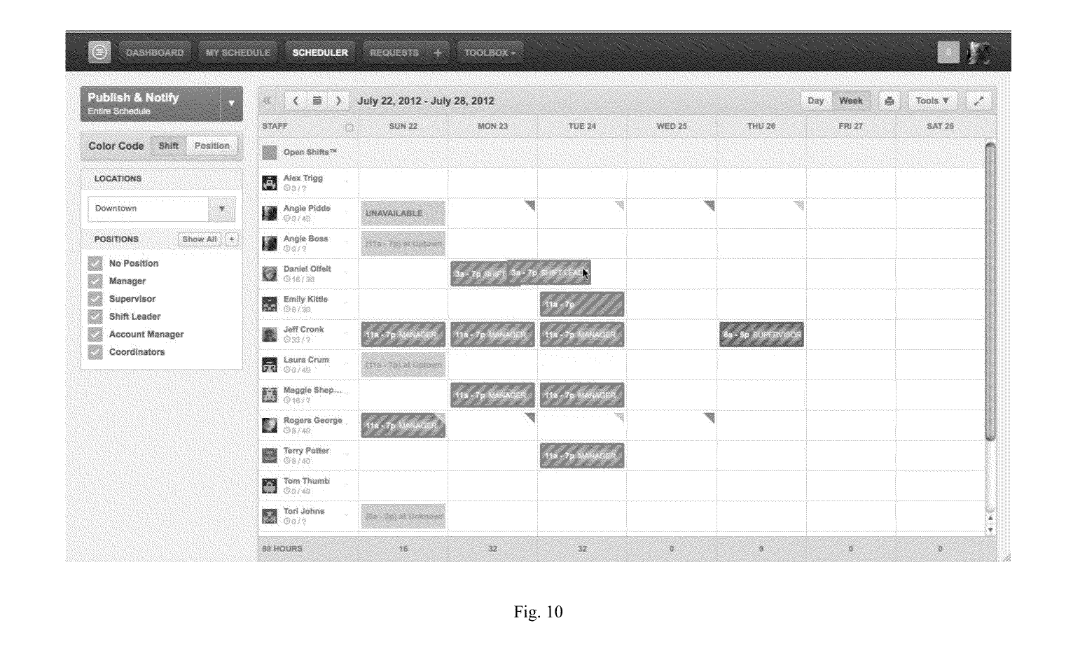

The employee can also indicate their preference for certain shifts. FIG. 7 shows “corner tabs” which can be used to indicate employee preferences. For example, Angie Pidde prefers the green shift (shift leader, 3 am to 7 pm) on Monday and Wednesday and prefers not to work Tuesday or Thursday. Rogers George also prefers the green shift (shift leader, 3 am to 7 pm) on Monday and Wednesday and prefers not to work Sunday or Tuesday. The color of the corner tab is connected with a color chart 20 as shown in FIG. 8 that indicates the position and shift time. In FIG. 8, for example, the green tab indicates the shift leader position from 3 am to 7 pm. Thus, when the employer sets the schedule, the user can simply go through and click and create shifts, or can copy and paste as described above (see FIGS. 8, 9, 10). FIG. 9 shows the scheduling of a supervisor to a Thursday shift. FIG. 10 shows the manager function added to multiple employees for various days on the way to creating a full week's schedule.

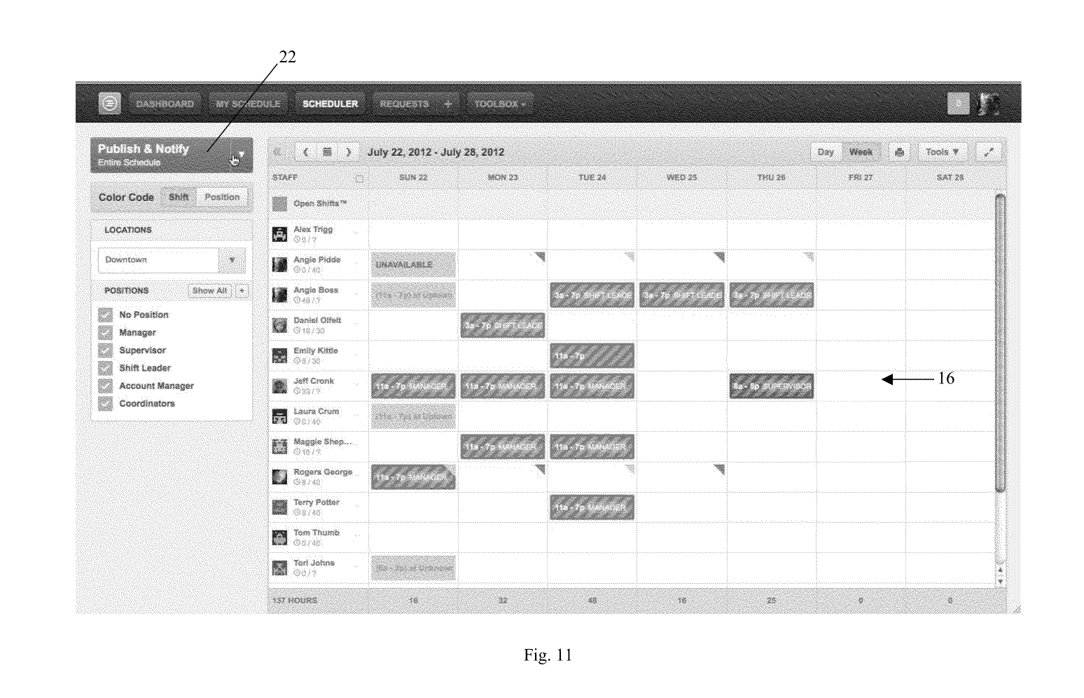

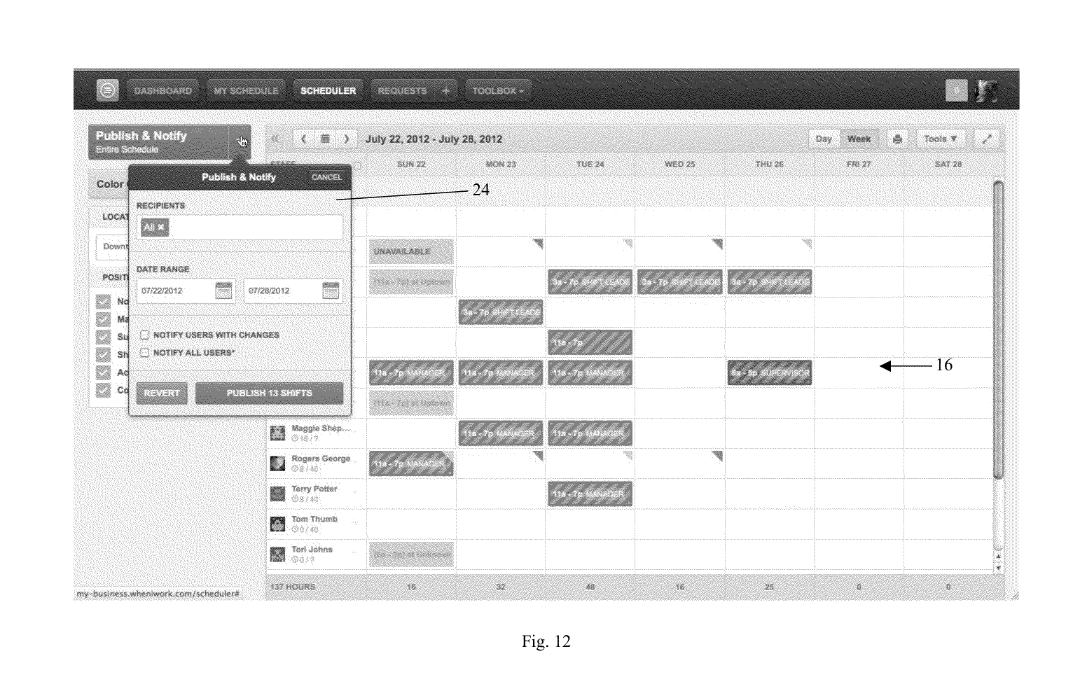

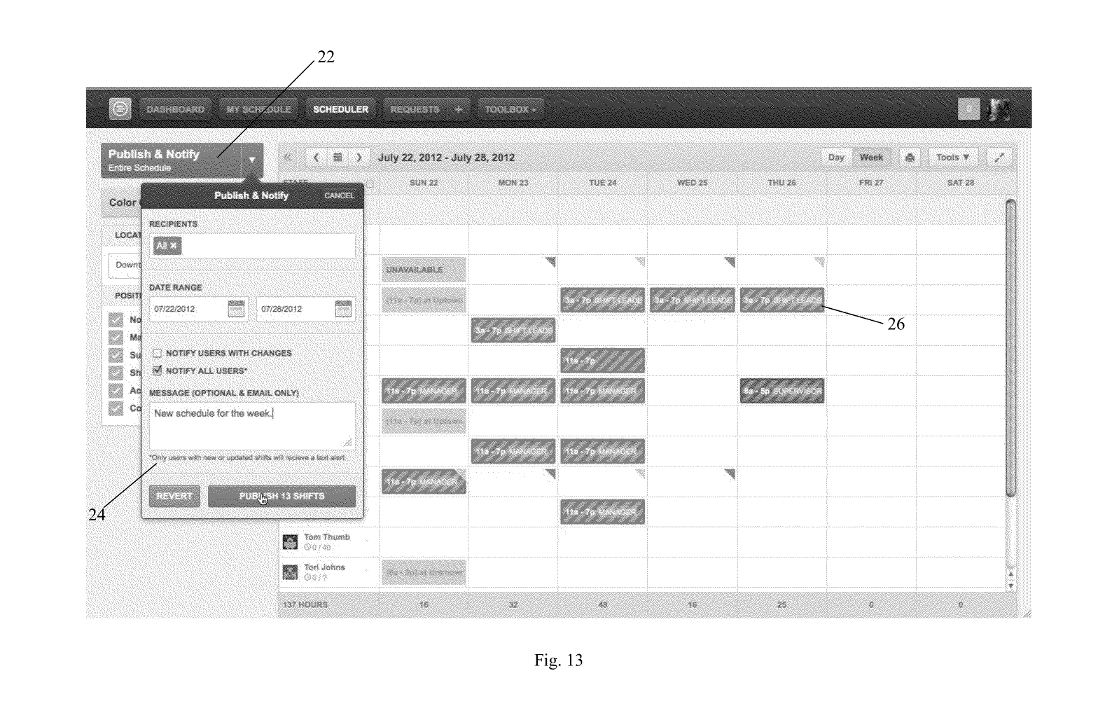

Upon completion of a week's schedule by the employer, the staff can be notified of its availability by “publishing” the schedule, such as via a green button (e.g., publishing widget) at the top of the screen (FIG. 11). This publishing widget can provide a choice of various options for publishing, such as shown at 24 in FIG. 12. For example, the employer can select whom to include as the schedule recipients (e.g., all employee and employers, all employees, only those employees scheduled, etc.), or the date range for the published schedule. The publishing widget can include an optional area for notes; for example, FIG. 13 shows a message that says “New schedule for the week.”

When the schedule is “published” (by clicking the “publish” button 22 in FIG. 13), the selected individuals (e.g., all employee and employers, all employees, only those employees scheduled, etc.) will preferably receive notification of the schedule. The notification may be in any one or more of various manners, for example: each employee can receive a unique email with their personal work schedule; each employee can receive a text message with their personal schedule; all employees can receive an email and/or text message informing them that the schedule is available and that they can view it online, on their mobile device (e.g., Smart Phone) or via text message.

After receipt of the notification (i.e., text message, email, etc.), the employee(s) can reply to notification with one or more of various key words that give them more information about their schedule. For example, an employee can reply to that text message with “do I work on Friday?” and the program can intelligently figure out if they have a schedule or if they have a shift on the upcoming Friday and it will text them back the answer. Voice recognition software including keyword look-up tables to facilitate this functionality are well-known. As another example, an employee can text the word “tomorrow” and the program can advise them if they are scheduled to work tomorrow. The employee can text any number of pre-selected keywords or phrases to the program so that the program can figure out what the request is and subsequently provide the requested information to the employee.

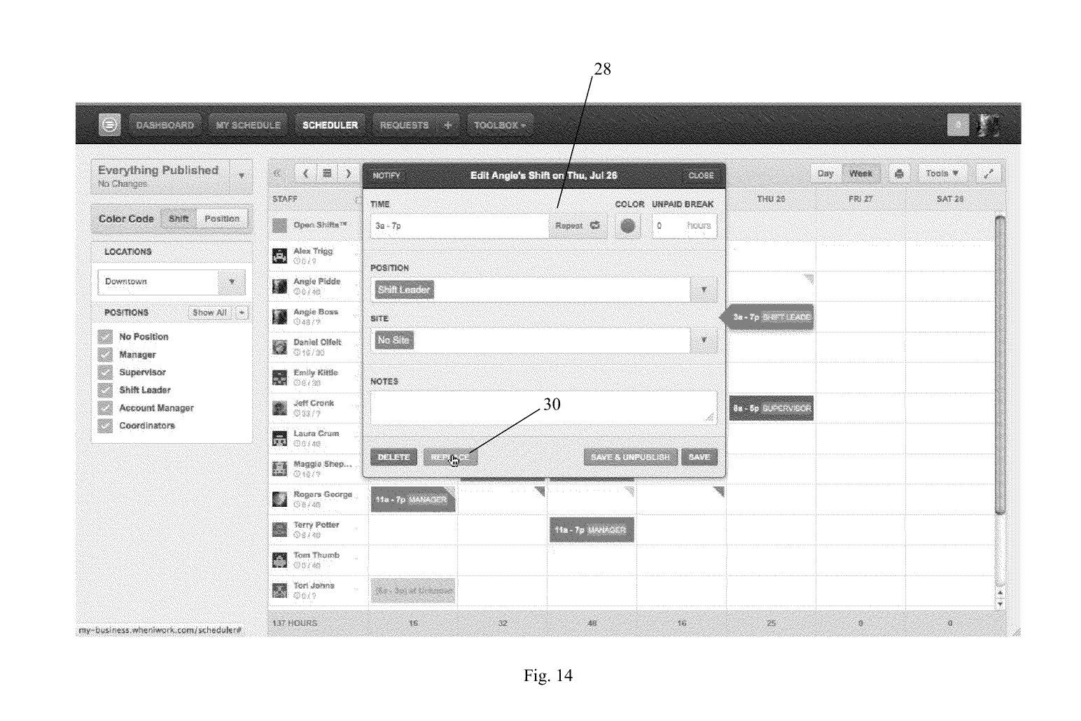

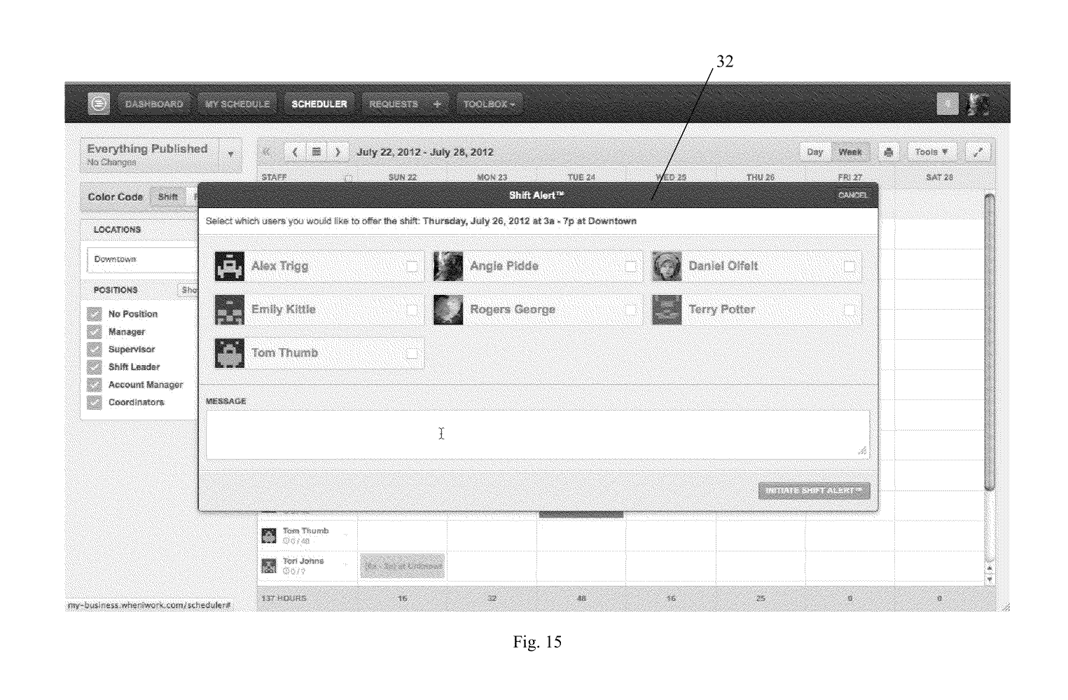

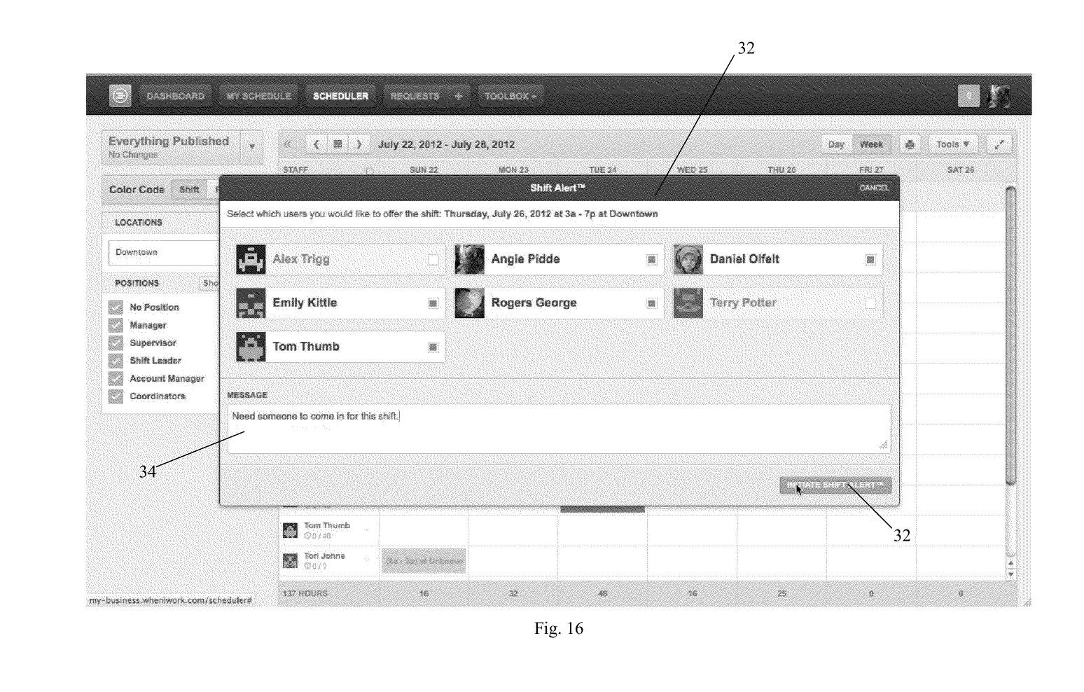

The Scheduler preferably also includes a “shift alert” feature, which can find a replacement employee available to work a designated shift. Referring to FIGS. 13 and 14, when Angie Boss's “shift leader” shift 26 on Thursday is clicked, the option to “replace” the employee with another employee is provided as shown at 30 in FIG. 14. The result of clicking on the replace button 30 is shown in FIG. 15, for example. The program preferably would have evaluated all employees for their availability and qualifications for the shift based upon known information and FIG. 15 shows seven employees (Alex Trigg, Angie Pidde, Daniel Olfelt, Emily Kittle, Rogers George, Terry Potter and Tom Thumb) in box 32 who qualify for the shift. The user can select which one or more of those employees is to be notified about the availability of that shift. FIG. 16 shows a note at 34 “Need someone to come in for this shift” being sent to Angie, Daniel, Emily, Rogers and Tom. Upon clicking “initiate shift alert” at button 36, an email and/or text can be sent to each selected employee to advise them that this shift is available. The employee can respond either through the website, via a mobile device (e.g., Smart Phone, tablet such as “Kindle™” or “iPad™”) or via text message with an answer, such as “accept.” The program will preferably recognize their reply based on keywords, as above, and then process the request appropriately and then automatically assign the shift based on the employee's reply. Simultaneously or subsequently, the employer can be notified as to which employee has taken the shift.

Employee Schedule Management

The program preferably also includes a component that allows an employee to personally manage their shifts while the employer can also be assured that any shift swap will not create a scheduling conflict. This feature provides collaboration and communication between the employer and the employee.

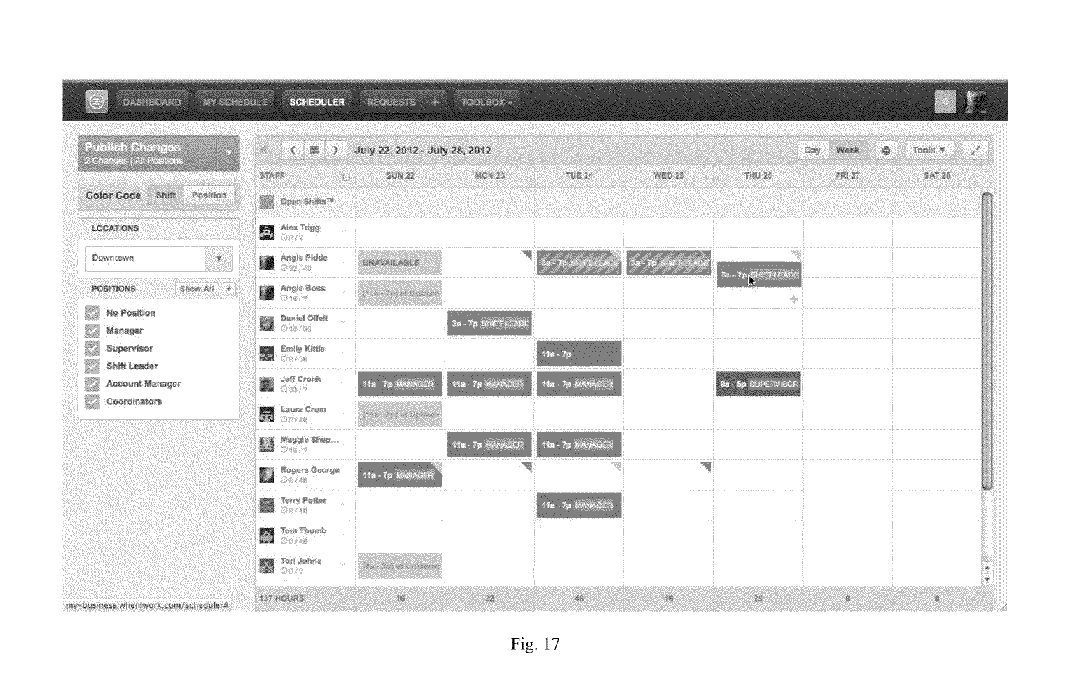

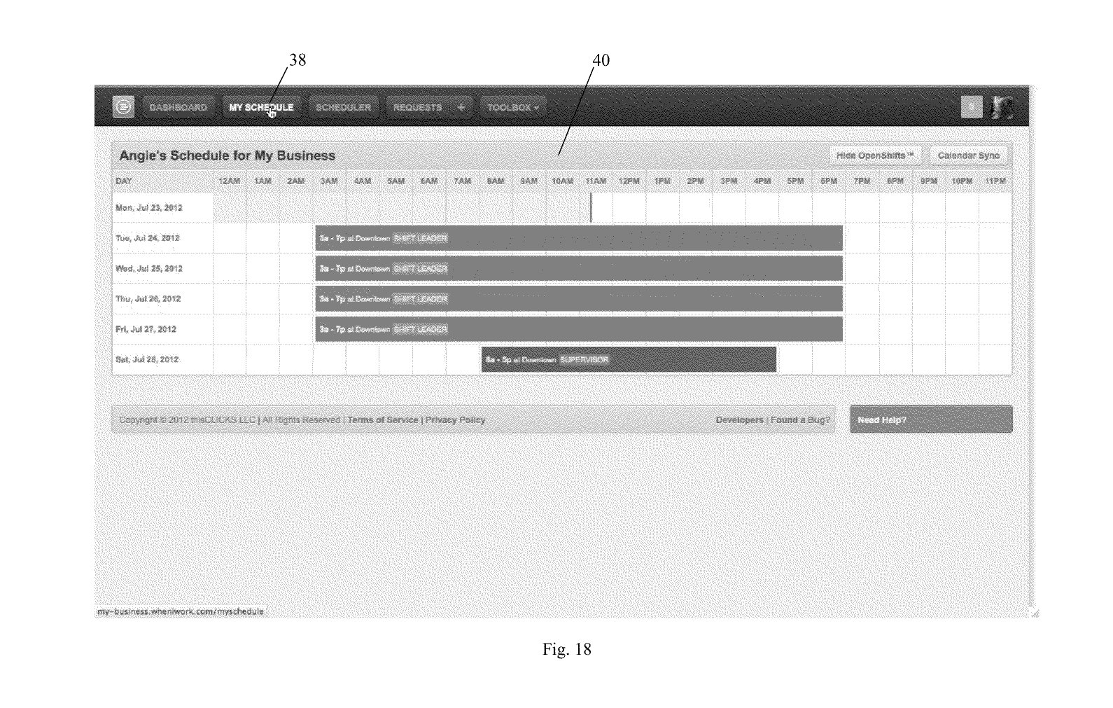

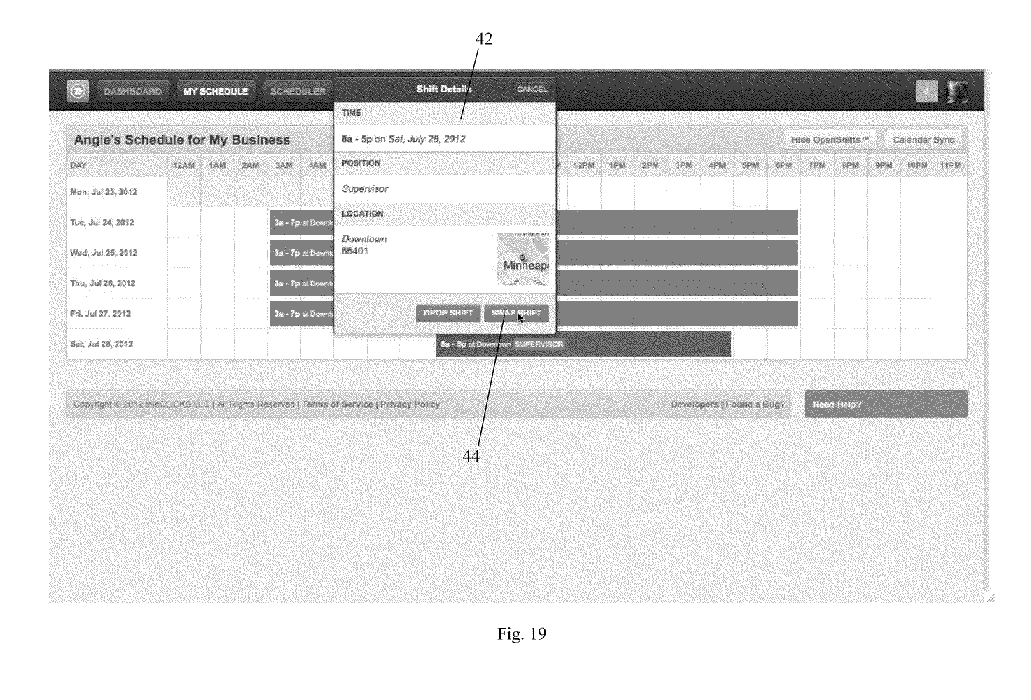

For this feature, the employee could log in as the user. Depending on the permissions assigned to that employee, as such permission control is well known for program information and manipulation access, the employee may be able to see the entire schedule such as shown in FIG. 17. From there, the employee (user) can access “my schedule” via a button 38 at the top left, which can show the employee's schedule 40 for the time period approved by the employer as shown in FIG. 18. Details regarding each shift can also be viewed such as in box 42 as shown in FIG. 19 such as by clicking on a particular shift.

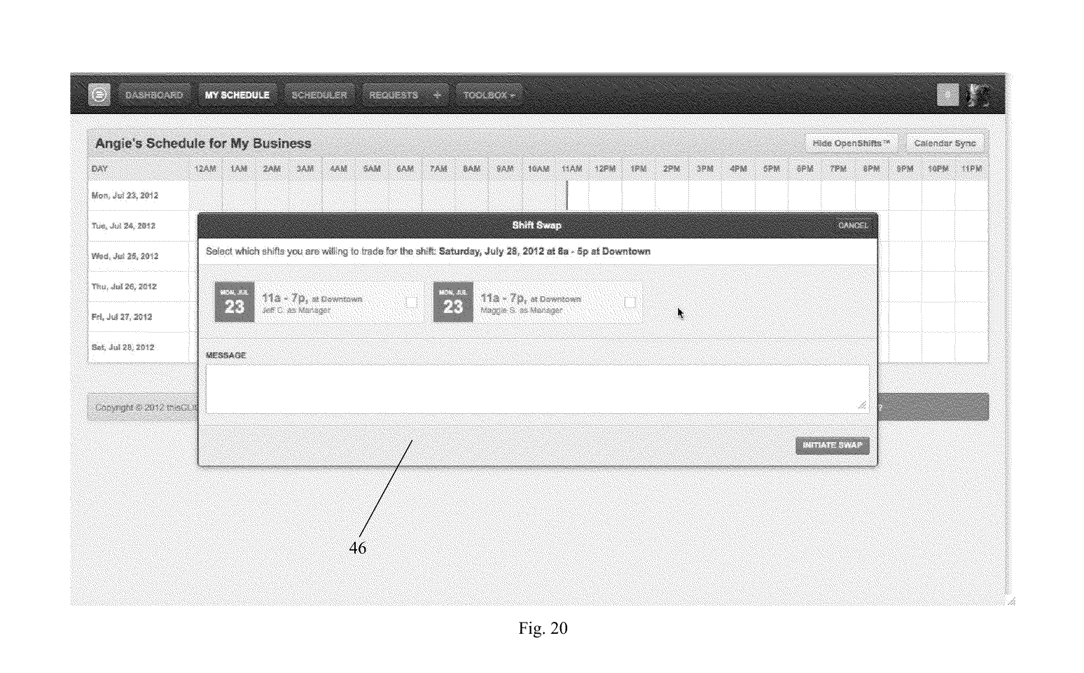

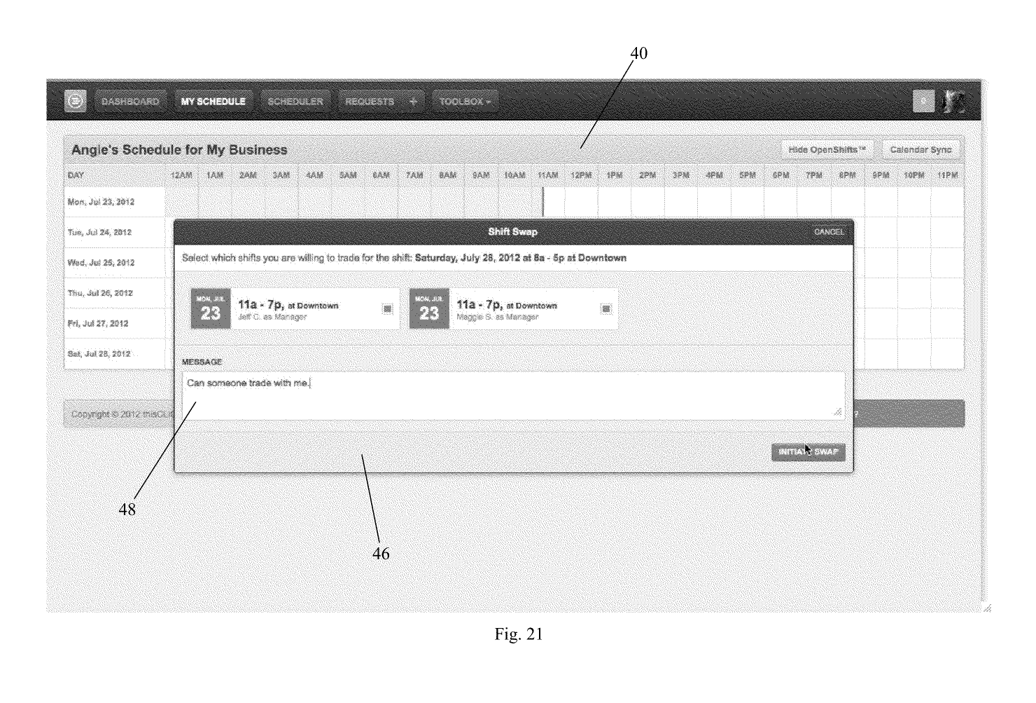

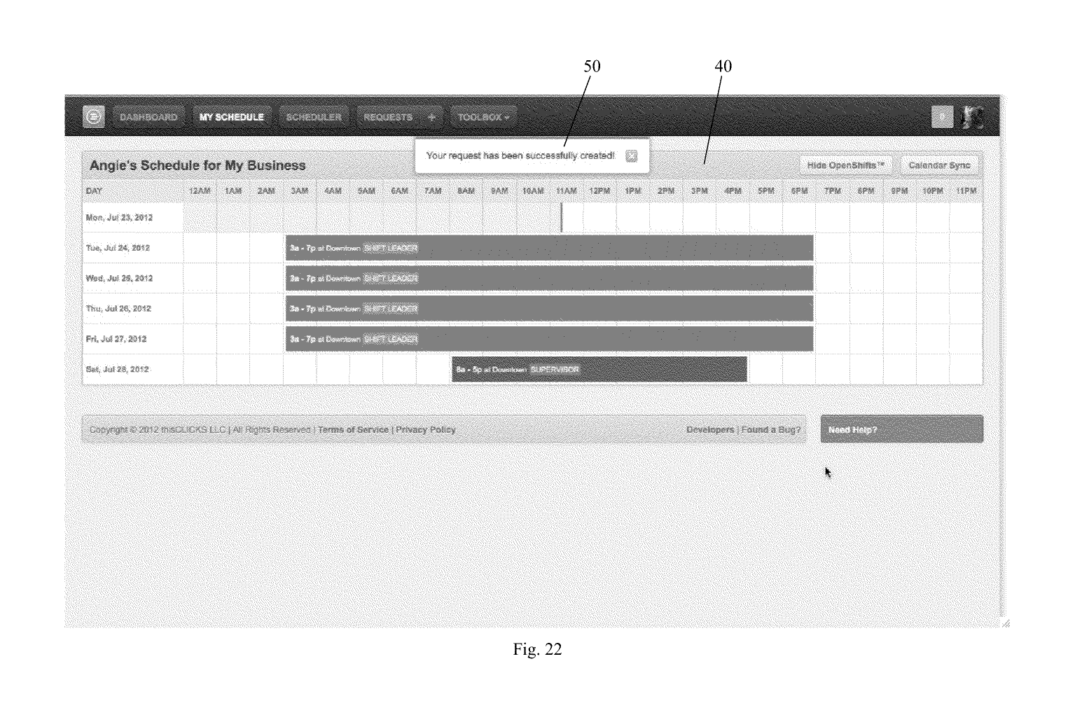

The employee (user) is preferably able to trade shifts with another qualified employee or to completely withdraw from or give away a shift. In FIG. 19, while viewing the shift details, the user can choose “swap shift” as shown at button 44. The program can then determine for which, if any, open shifts the user is qualified and can present those shifts to the user. Additionally, the program can instead show shifts assigned to other qualified and available employees who might be available for switching with the user's selected shift. In FIG. 20 for example, the user sees in box 46 that Jeff C. and Maggie S. both have “manager” shifts on Monday the 23^{rd} from 11 am to 7 pm. As shown in FIG. 21, the user can contact Jeff and Maggie with the message “Can someone trade with me” in the message box 48. The employer also preferably receives a notice (via email, text, etc.) that the employee (user) has requested to trade shifts with one of these two employees. FIG. 22 shows a verification notice so as may be seen by the requesting employee (user).

Depending on control of permissions as can be set in place in the program, the employer may have the authority to override or modify a request from an employee (user). For example, the employer can approve the trade request as it is, can remove one or more of the employees from the trade request, or can deny the trade. This can also preferably be done by the employer via mobile device, text message or website. After employer approval, the appropriate email and text message can be sent to the selected employees, who can reply via email, text message, via mobile device app, or by logging onto the website, as described above.

Budgeting

The program preferably additionally includes a budgeting feature, such as for expense tracking, payroll tracking, and the like. This feature can provide a very quick and easy way for an employer to determine payroll expenses and the number of hours that have been scheduled or need to be scheduled per employee.

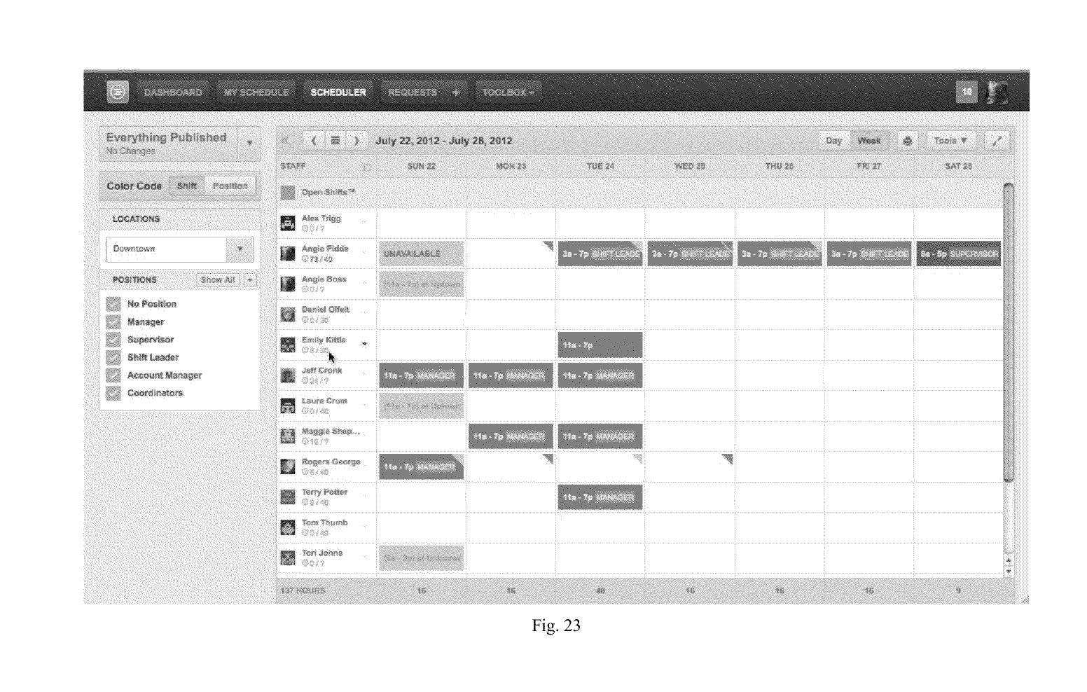

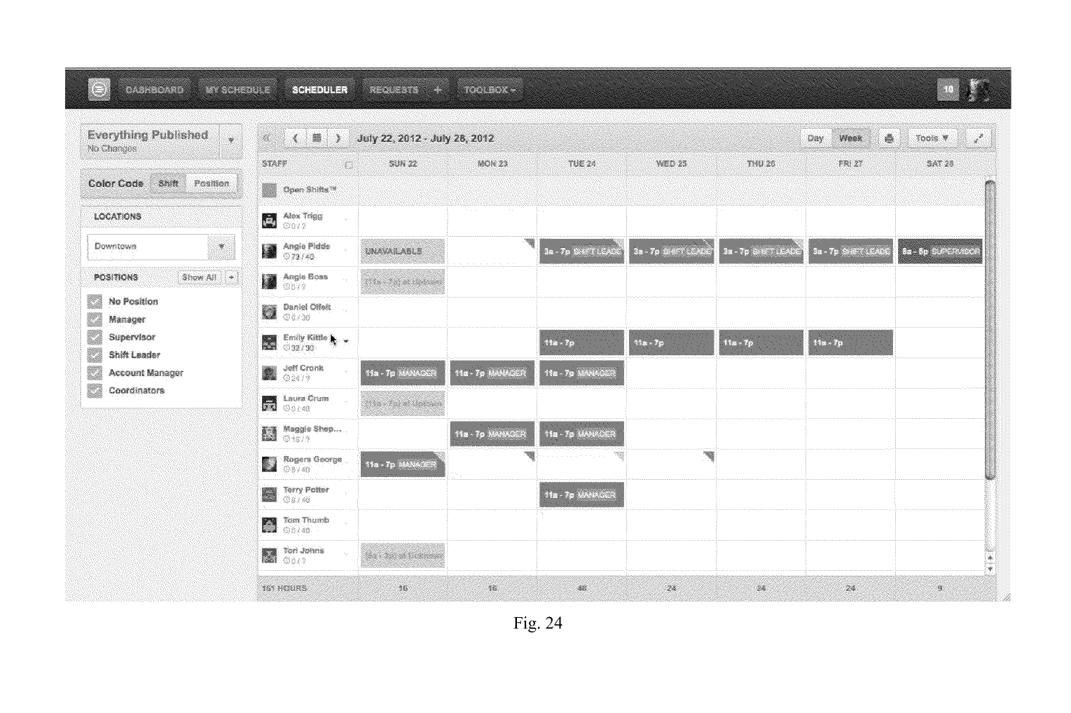

For example, when in the Scheduler mode, as seen in FIG. 23, below each employee's name one or more numbers can be indicated. A first number (and only number, for those having only one number) preferably represents the number of hours for which that employee has been scheduled. This number preferably changes in real time as shifts are added or removed. A second number, for those employees who have it, can indicate a maximum allowable hours. As can be seen in FIG. 23, employee Emily Kittle has scheduled 8 of her maximum 30 hours as indicated by the numbers 08/30 below her name.

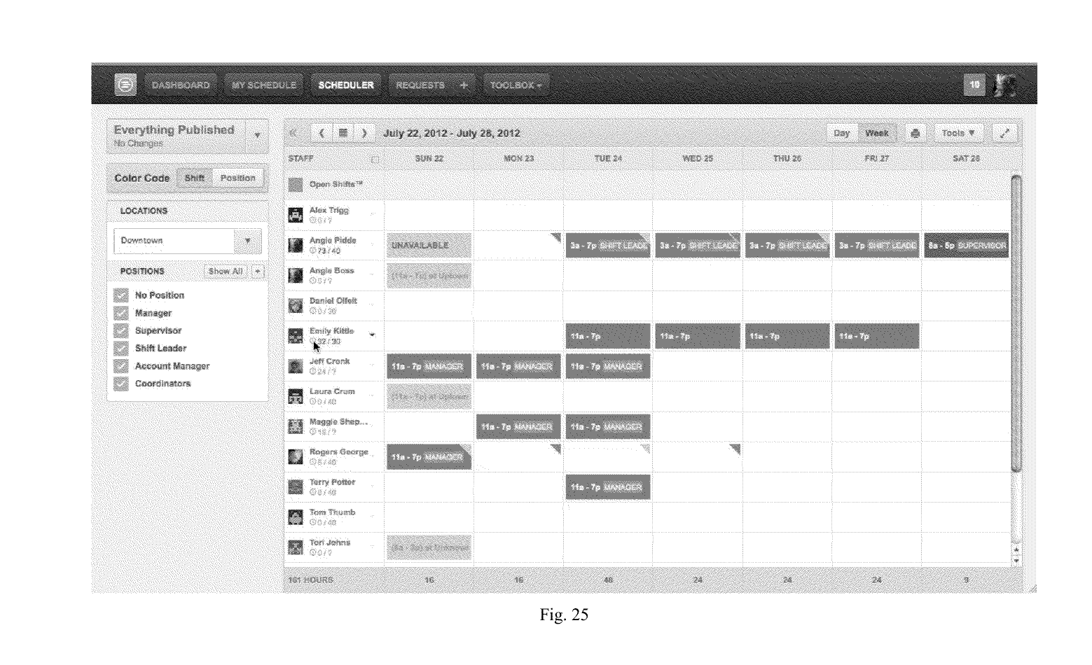

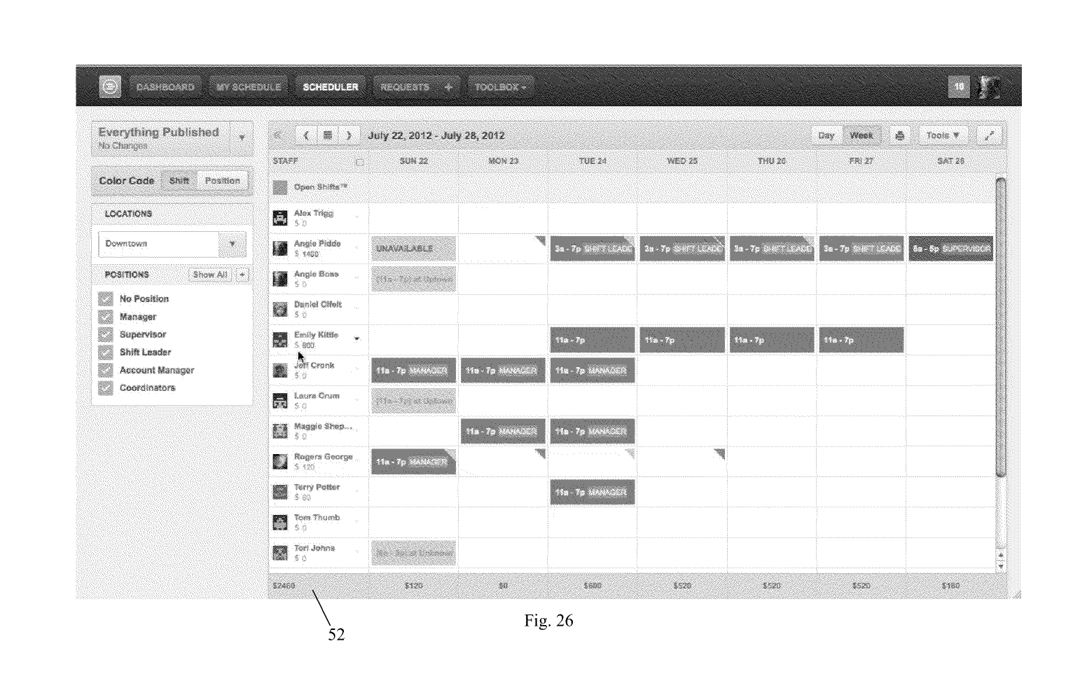

FIG. 24 shows what can happen if the maximum hours is exceeded for an employee. If Emily is scheduled for 32 hours, the color of the numbers preferably changes to red, advising that the scheduled hours is over the maximum allotment, which might result in overtime expenses, require additional benefits, etc. As noted above, the program can include hourly wage for each employee; thus, the program can provide the monetary cost of each hour or shift for the employee. By clicking a small “clock” icon illustrated next to the numbers in FIG. 25, the number value can switch to expenses in dollars ($), as seen in FIG. 26. Based on the hourly rate of the employee (Emily) for example, the expense for this employee is anticipated to be $800 for this week as shown instead of the hourly numbers.

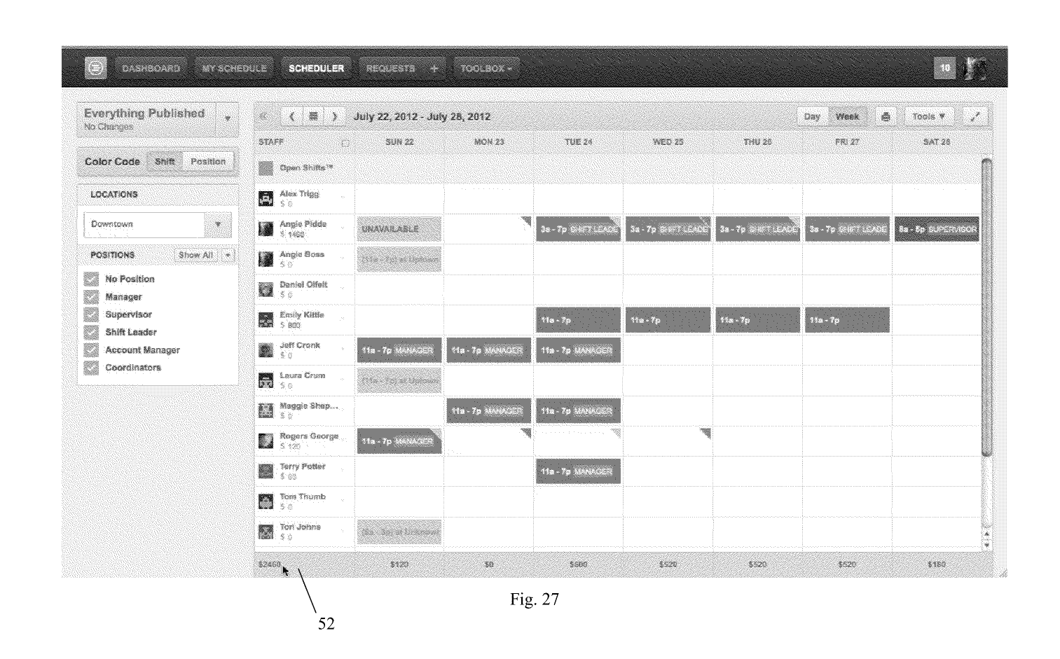

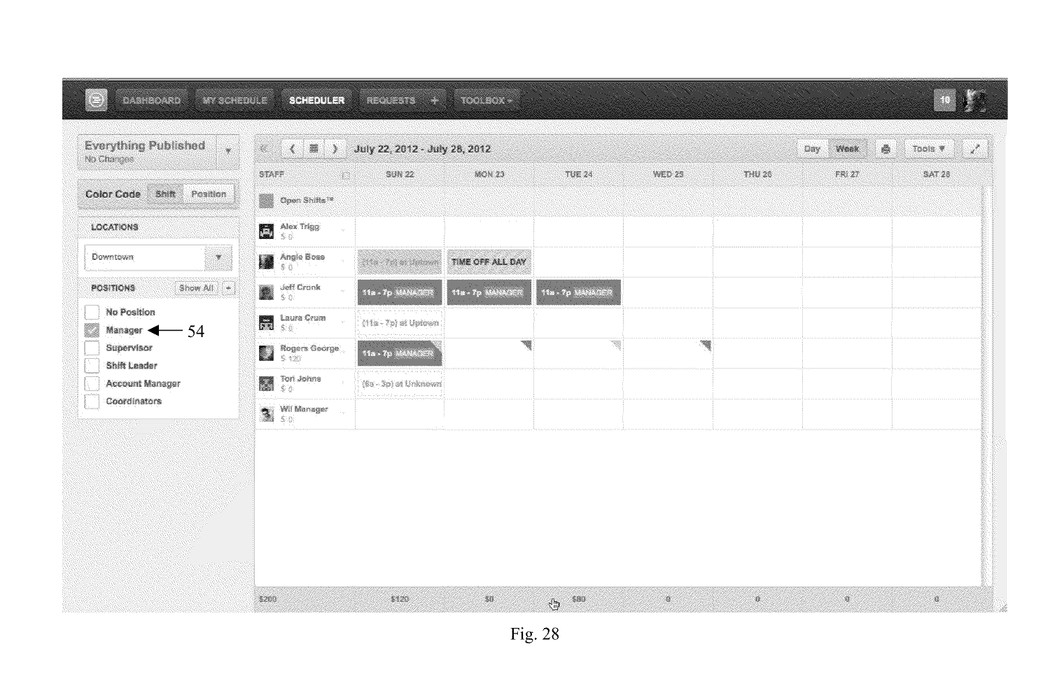

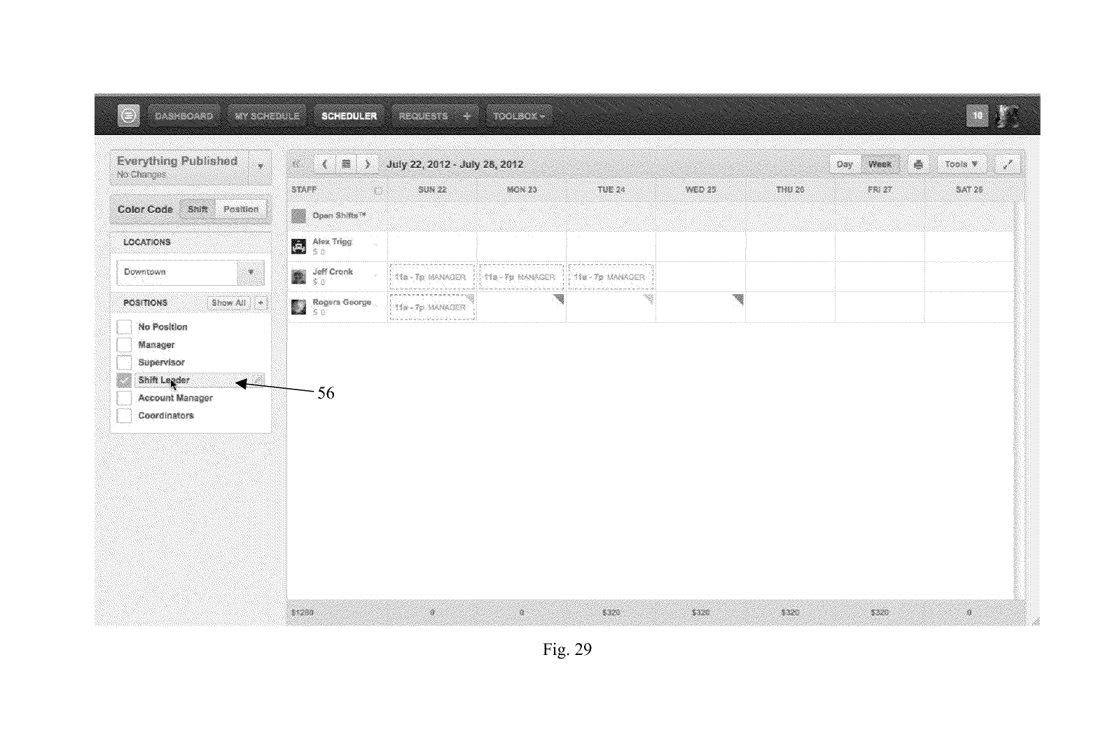

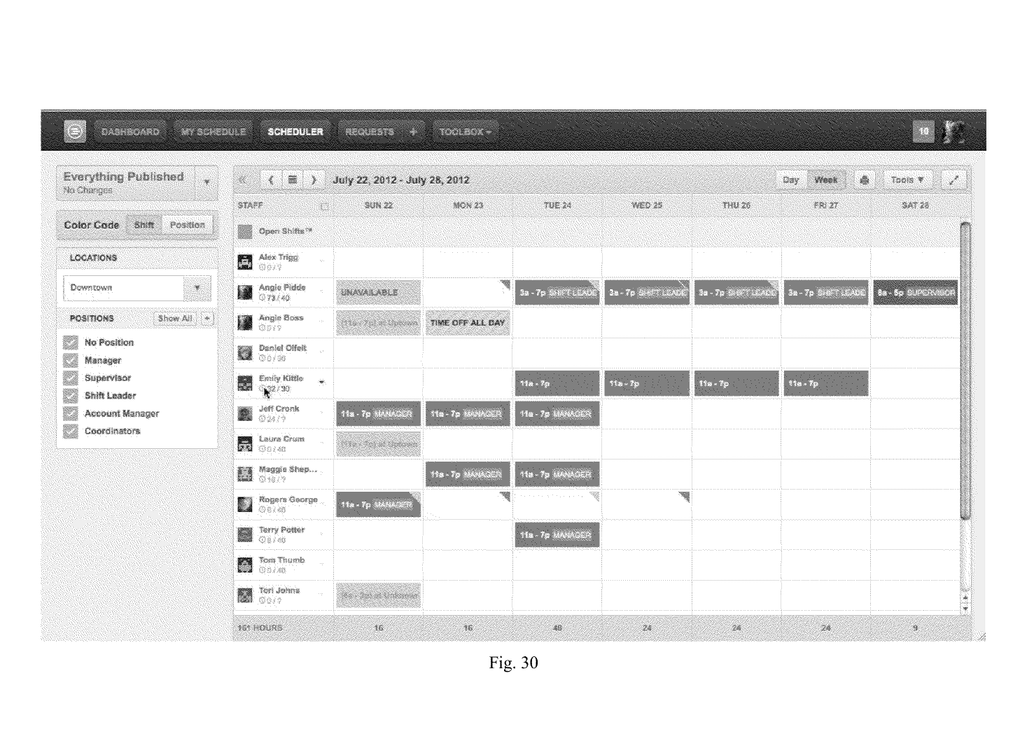

At the bottom of FIGS. 26 and 27 at box 52 the total expense for all employees scheduled for the week can be tabulated and shown, such as $2,460. Additionally, the total for each day, for all employees, can be summarized. This can also be reduced to the expenses per job function. As shown in FIG. 28 for example, only “managers” can be ticked at 54 on the left hand side of the screen. With only “manager” shifts activated, only the manager shifts and manager expenses are preferably shown. In FIG. 29, only “shift leader” is ticked at 56, thus showing only shift leader shifts and expenses. To revert back to hours (rather than expenses), the dollar sign ($) is preferably clicked as shown in FIG. 30 at the toggle location of the clock as above.

Determining Qualification of Employee

The program further includes a qualification determining feature, which adds to the intelligent nature of the program. This qualification determining feature is an integral part of the scheduling feature of the program. When an employee is entered into the program, their qualifications are preferably also inputted in the system. For example, one employee may be qualified to fill the “manager”, “supervisor”, “shift leader” and all lower level positions, a second employee may be qualified for “cashier” and “shift leader”, whereas a third employee may be qualified for “cashier”, “floor”, and “stock”. Any shift, or a block of shifts, may be designated to only be filled by employees with certain qualifications. This shift designation is referred to herein as “a pre-qualification”, “pre-qualified”, or variations thereof for types of shifts available.

The program preferably also shows for which shifts or shift blocks an employee is qualified. If a shift or shift block is pre-qualified, those shifts can be then shown and highlighted. If a shift is not pre-qualified, then the program assumes that the employee is qualified for that shift, providing the option for the user to assign that shift to that employee.

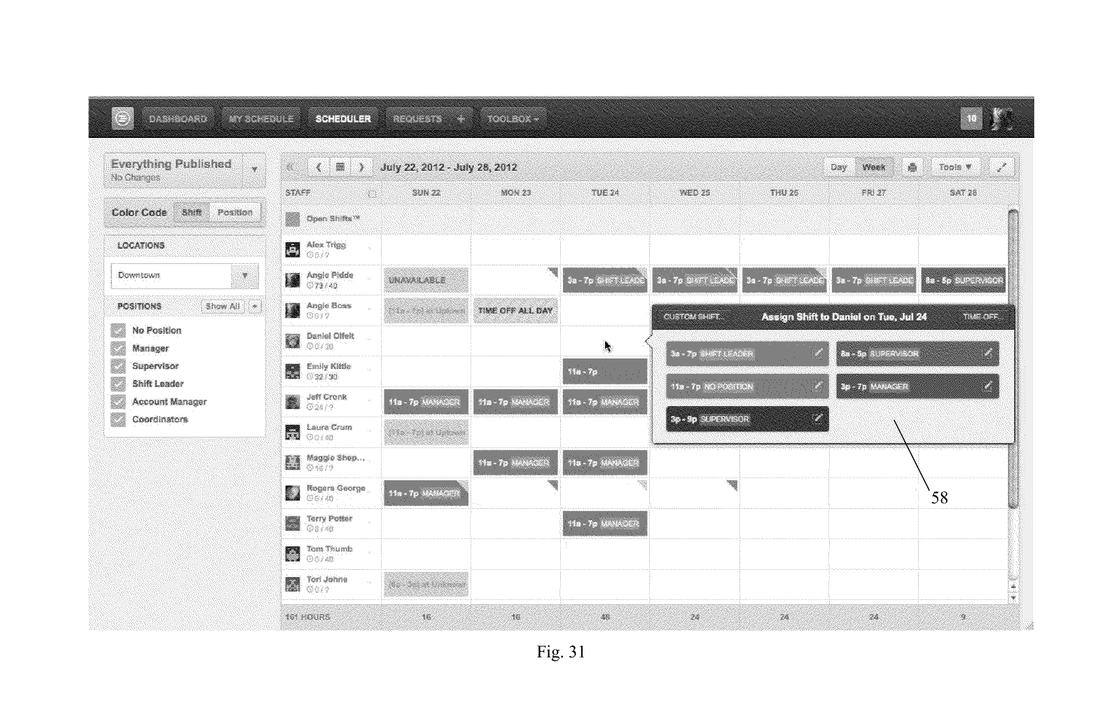

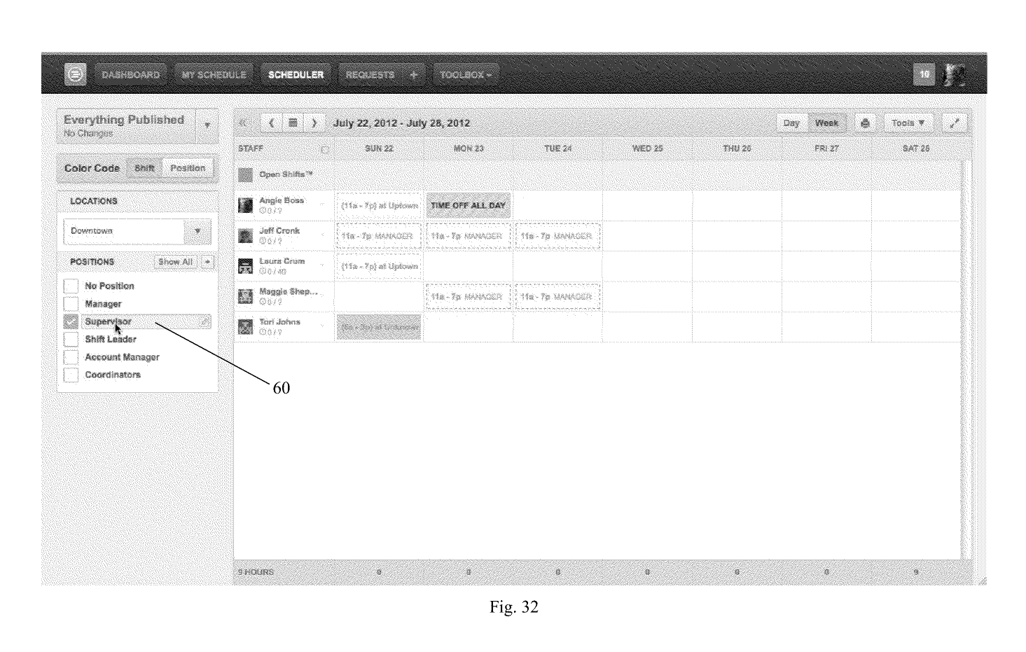

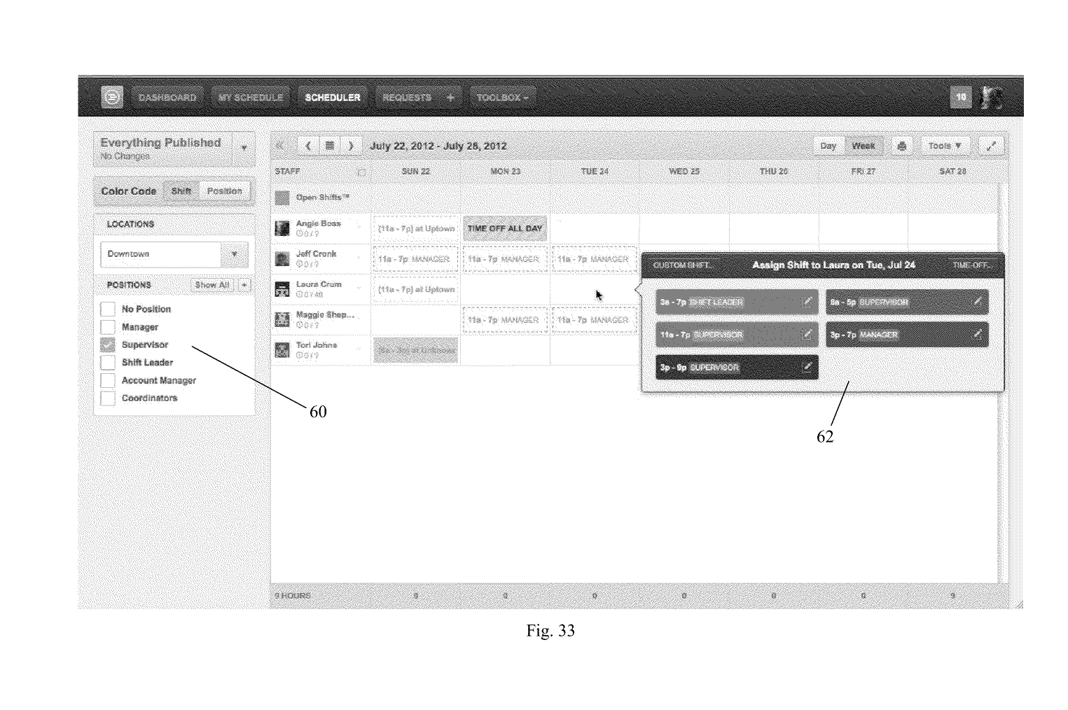

For example, FIG. 31 shows that when a day for an employee (e.g., Daniel) is clicked, preferably the program shows the shifts on that day for which this employee is qualified within a box 58. The program also preferably allows the user to view which employees are qualified to cover a shift, if that shift has been assigned a pre-qualification requirement. As shown in FIG. 32, “supervisor” can be checked on the left side of the screen at 60 and this shows all pre-qualified “supervisor” shifts and which employees are qualified to cover those shifts. When a day is selected (e.g., Tuesday in FIG. 33), the program will preferably assume that, for any shifts not set with a pre-qualification requirement, the desired qualification is that which is checked on the left side of the screen (i.e., “supervisor” in FIG. 33). In the example of this particular figure, most shifts are going to be set to “supervisor” because these particular shifts have not been predetermined with a qualification, as has the (green) shift for “shift leader” and the (purple) shift for supervisor.

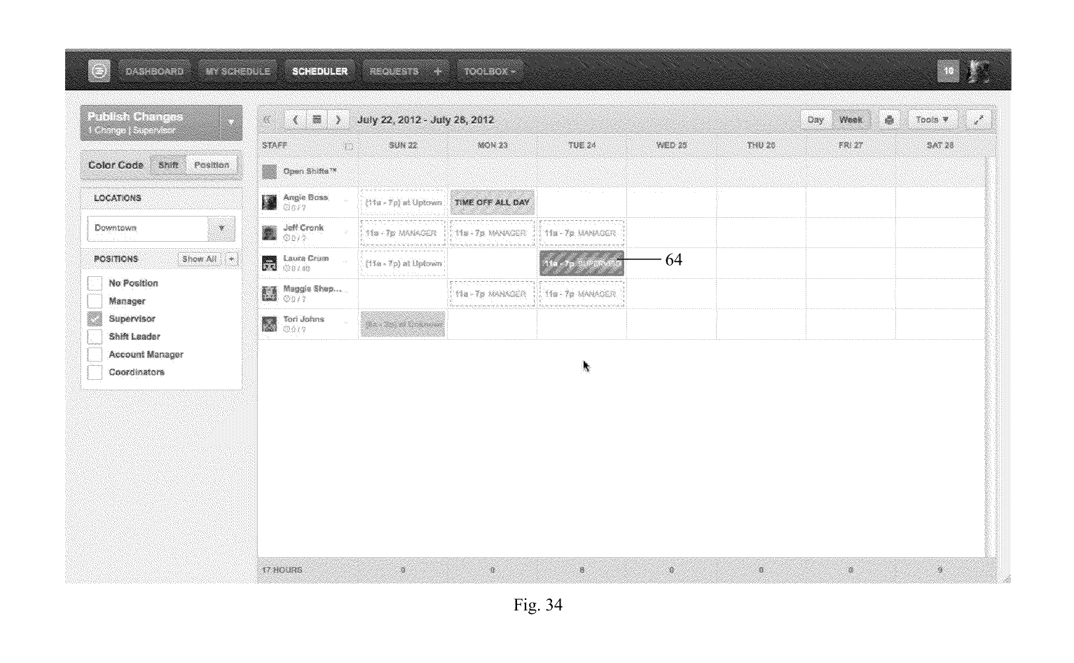

The user can select the shift (e.g., “supervisor”) within box 62 and thereby assign the shift to a qualified employee. FIG. 34 shows a “supervisor” shift assigned to employee Laura for Tuesday at 64.

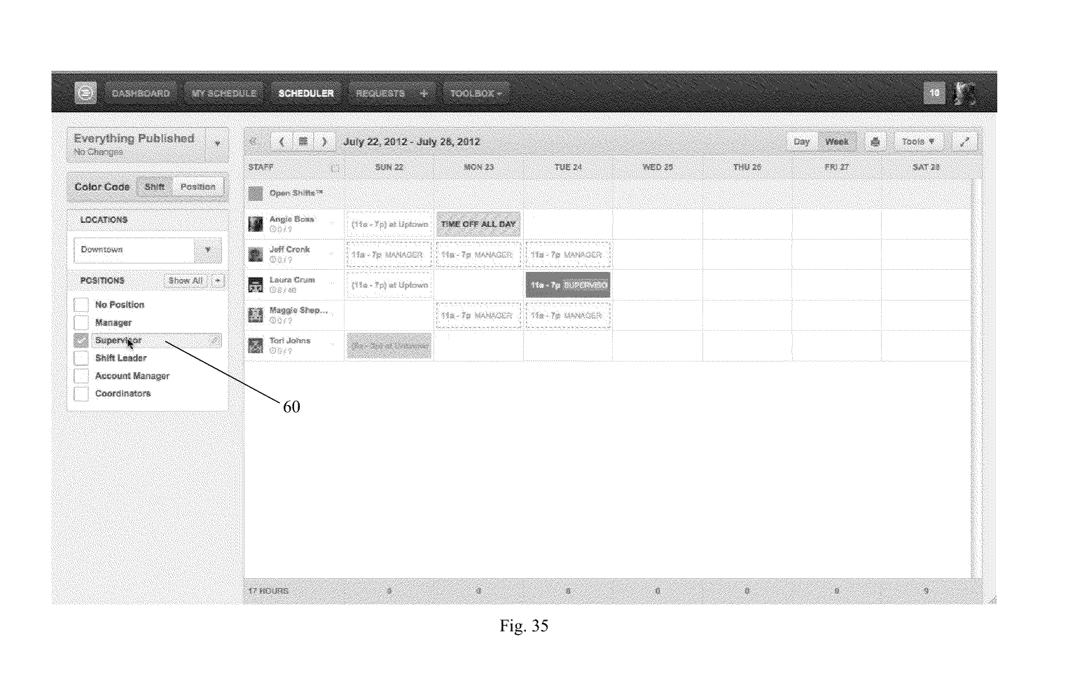

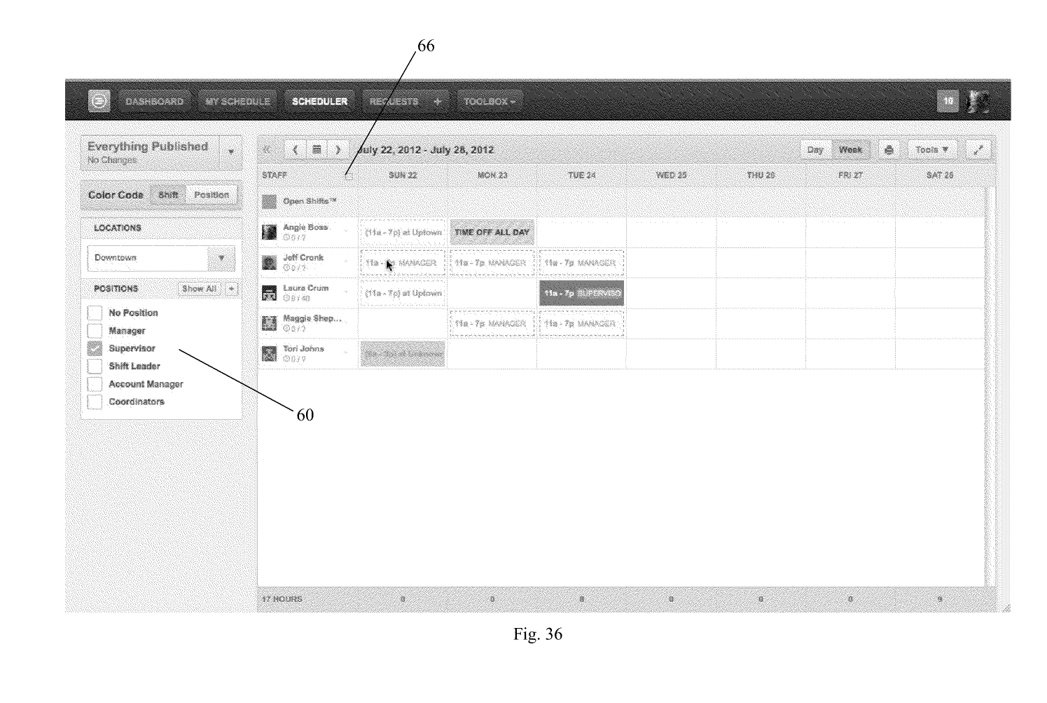

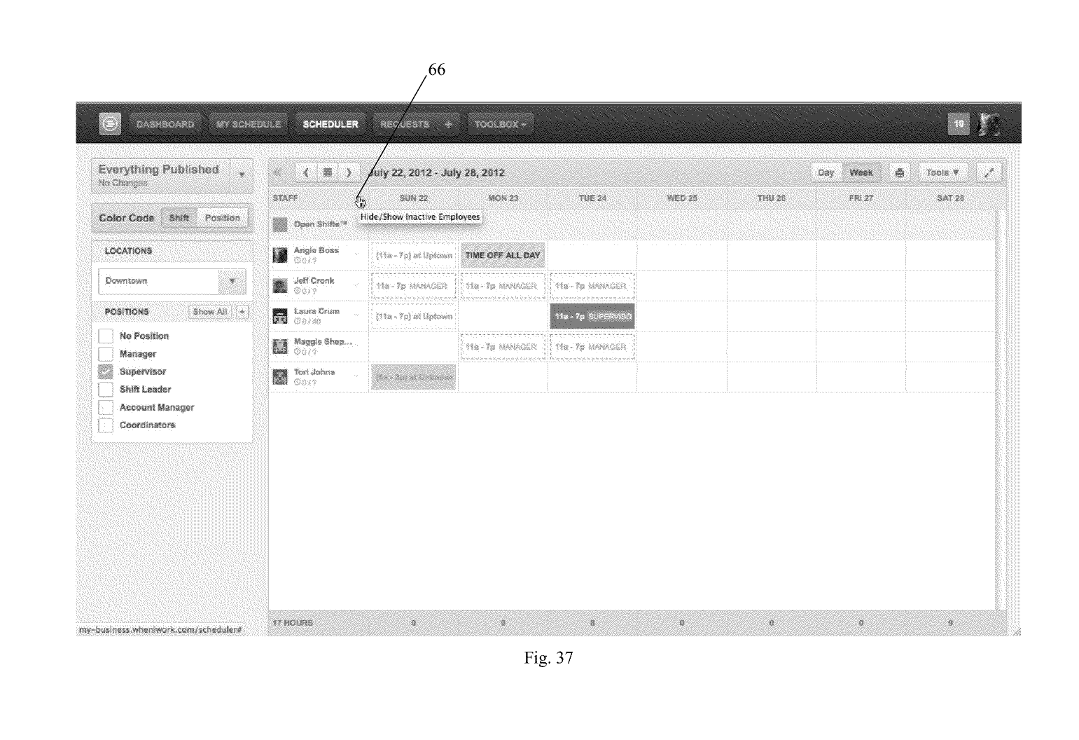

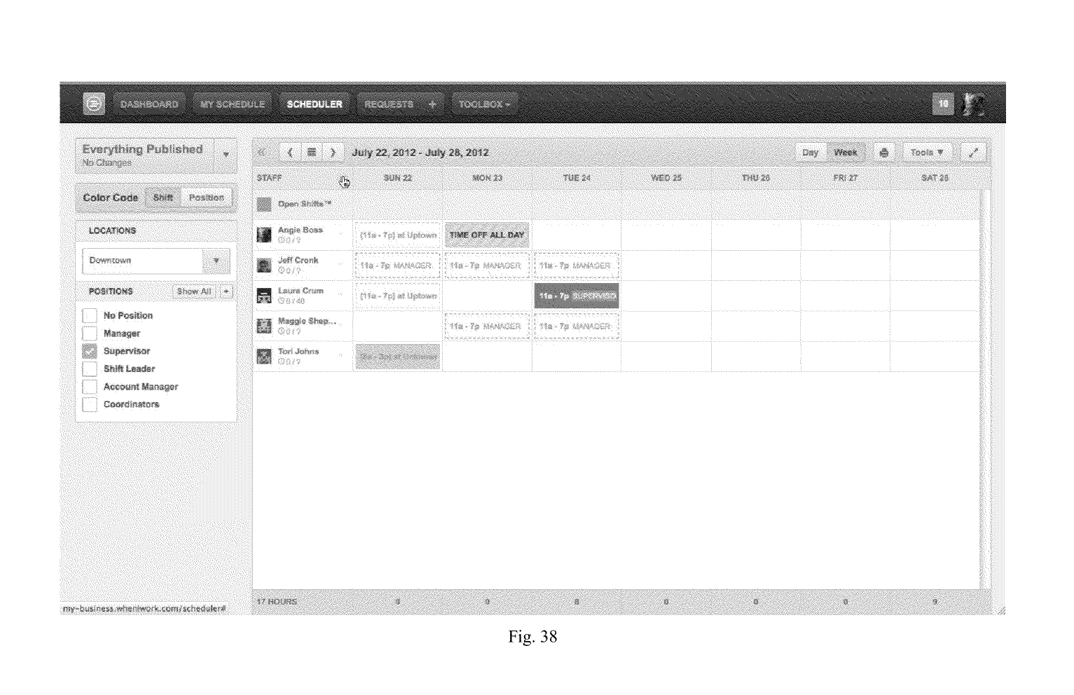

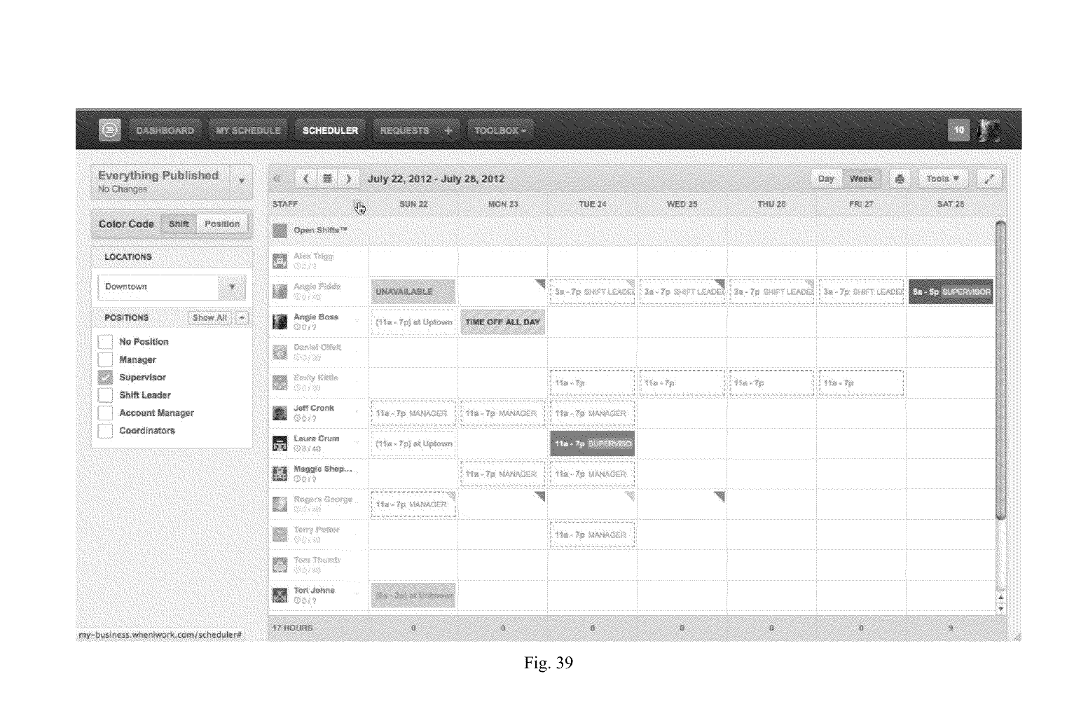

FIGS. 35 and 36 show a schedule for those employees qualified for a selected shift. For example, in FIGS. 35 and 36, if the “supervisor” shift for an employee is selected at 60, all other employees who qualify to work that shift are shown, with their currently scheduled shifts preferably represented with a dashed line. With this, the employer can quickly know which employees are qualified for a supervisor shift but who have other shifts that they have been assigned in other qualifications in other positions. A toggle button 66 in FIG. 37 can filter or consolidate the view based on the selected positions. The view in FIG. 38 shows only employees that are qualified as a supervisor. Alternately, all active and inactive employees (thus, all employees) can be shown, with inactive employees dimmed or “grayed out” compared to the qualified employees as shown in FIG. 39. This provides the ability to see all employees and differentiate between those qualified for the position and those who are not.

Employee Self Scheduling Via “Open Shifts”

Yet another preferred feature of the program of the present invention allows the employer to select one or multiple shifts that are not assigned to a particular employee, but are left available for employees to individually select (e.g., self-schedule). The user interface of the program is preferably sufficiently uncomplicated and logical so that no detailed training of the employees is needed in order for employees to use the program to self-schedule.

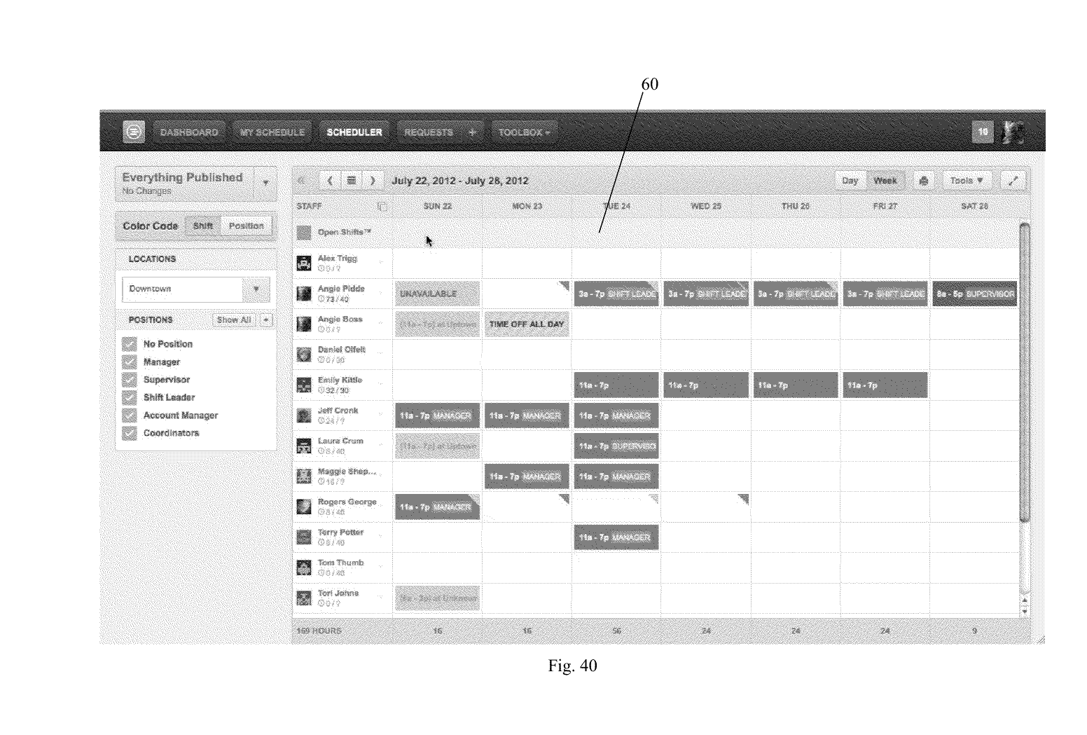

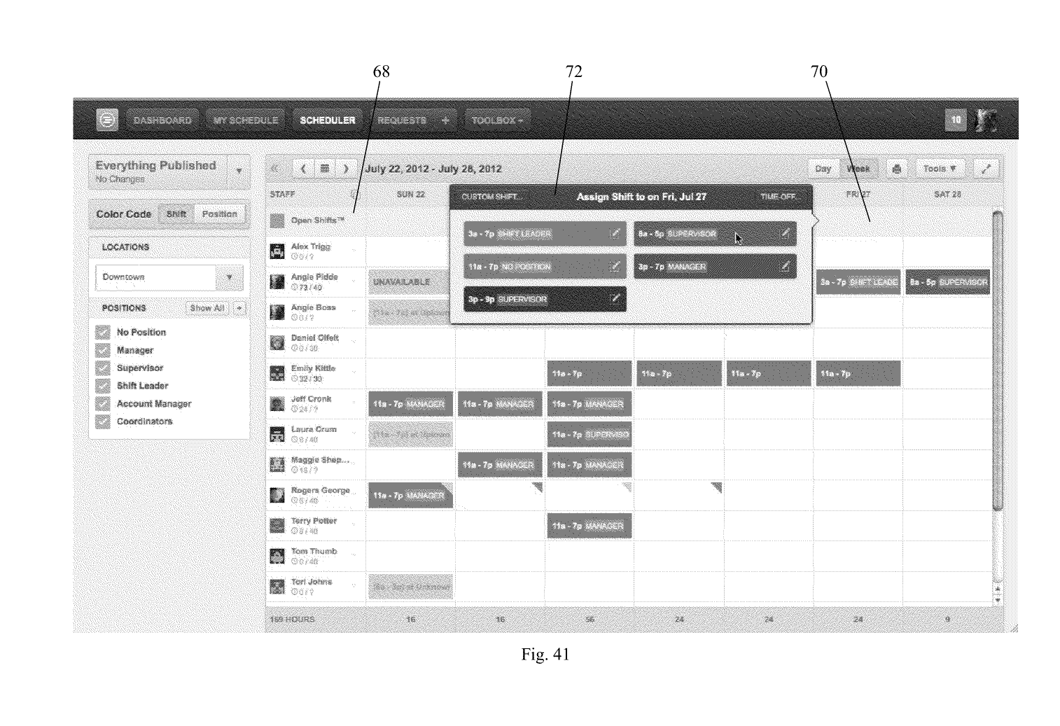

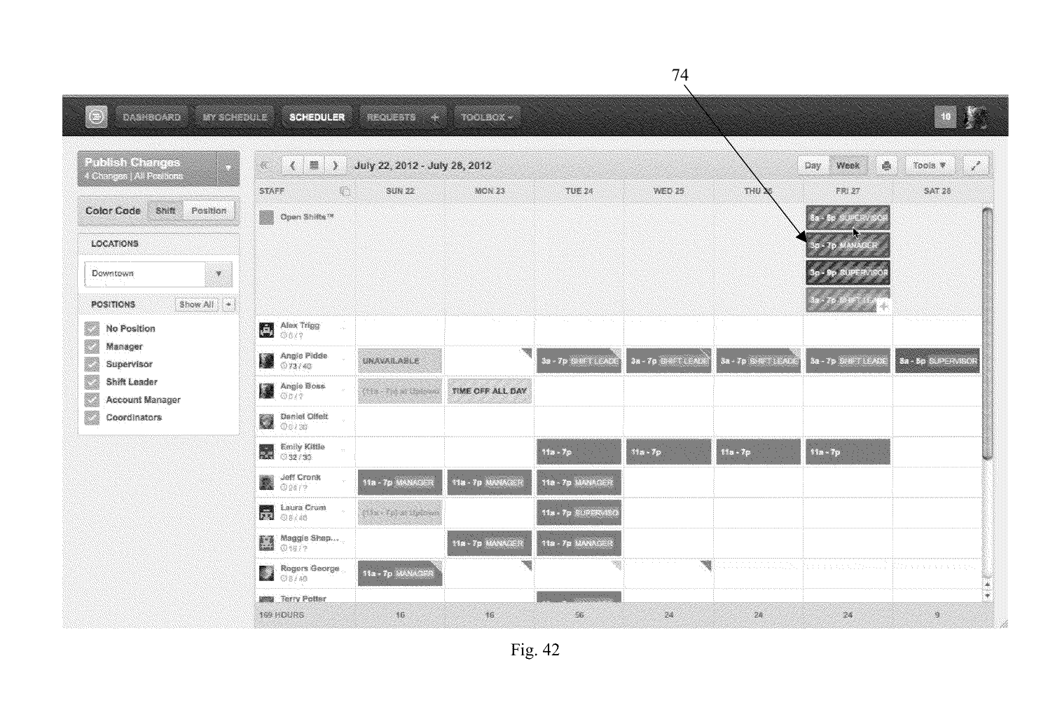

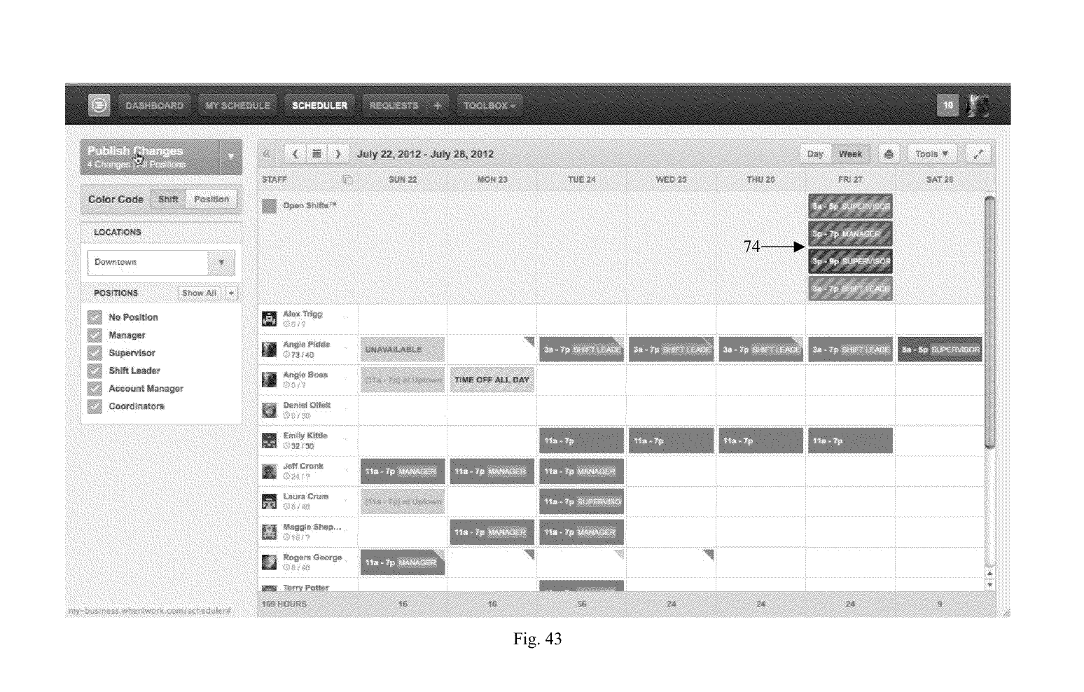

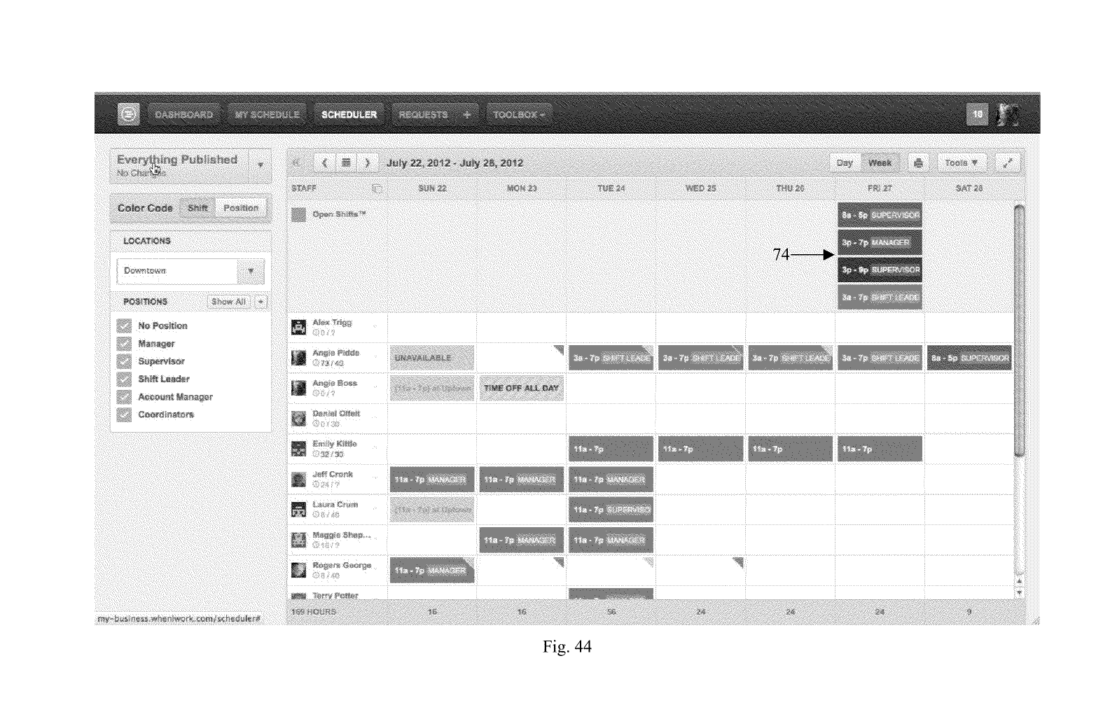

Returning to the main Scheduler page (FIG. 40), a lime-green line 68 at the top of the schedule can be provided for the employer, the line designated as “open shifts”. The employer can select a day (e.g., Friday, in FIG. 41 at 70) and from the five shown available shifts in box 72, select the shifts to designate as “open”. FIG. 42 shows four shifts designated as “open” at 74 and FIG. 43 shows these available shifts being “published” as open (see cursor on top left of FIG. 43). After being published (FIG. 44), any qualified and available employee for any of these shifts is able to see them (e.g., via mobile device app or the website). Employees can elect to accept any of these offered shifts, providing a sense of control for the employee. After selection by an employee, the employer can be notified (via email and/or text message) that the shift has been filled.

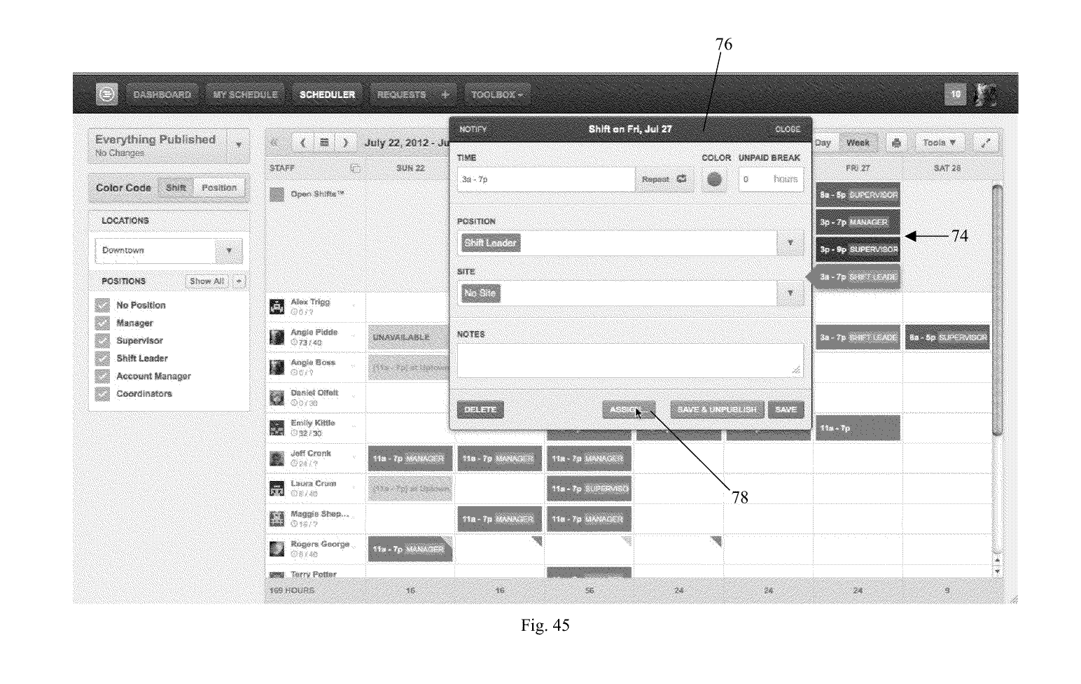

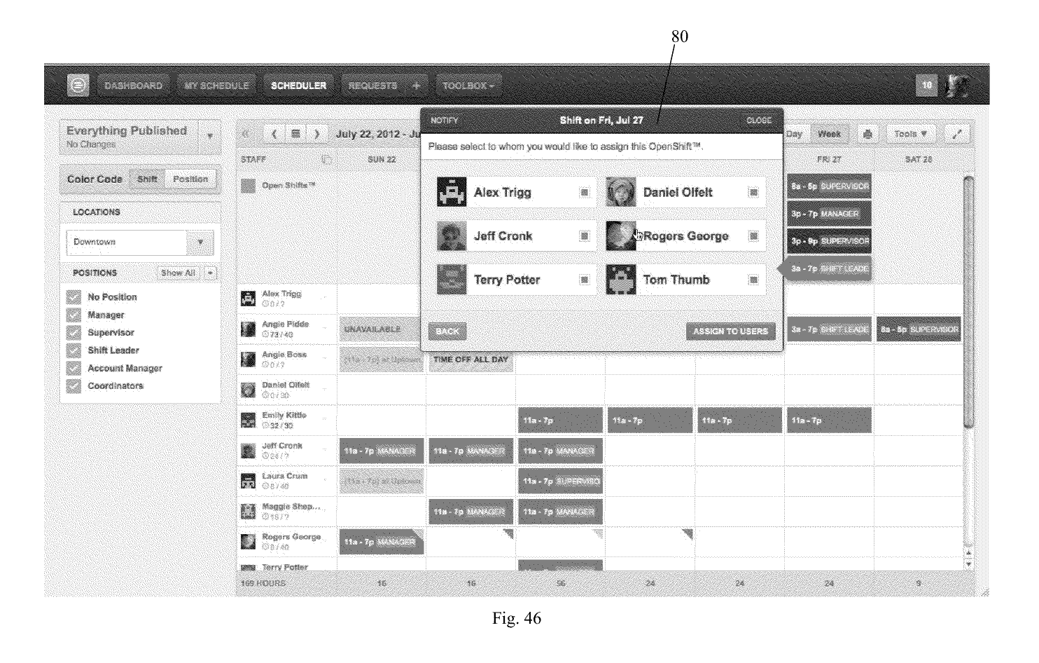

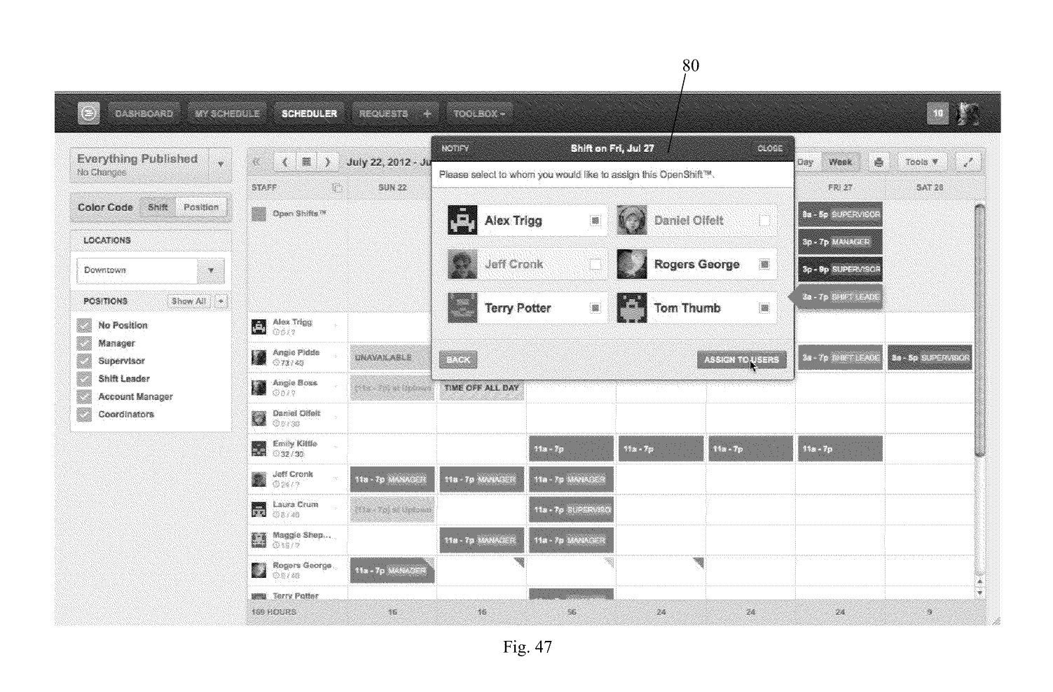

If the employer desires to limit the employees who may take a particular shift, the employer may limit the shift to only selected employees. By clicking on the shift as listed at 74, the employer is given the option, as in box 76, to directly assign employee(s) to the shift as shown in FIG. 45. From the “assign” button 78, the program will preferably list those employees that are available and qualified to fill that shift as shown in box 80 of FIG. 46. Employees can thus be given access to the shift or have access to the shift removed. In FIG. 47, employees Jeff Cronk and Daniel Olfelt, for example, are removed from being able to elect the selected “shift leader” shift by unticking the box next to each name. Only the selected employees (Alex Trigg, Terry Potter, Rogers George and Tom Thumb) are able to see and elect the shift through their modalities.

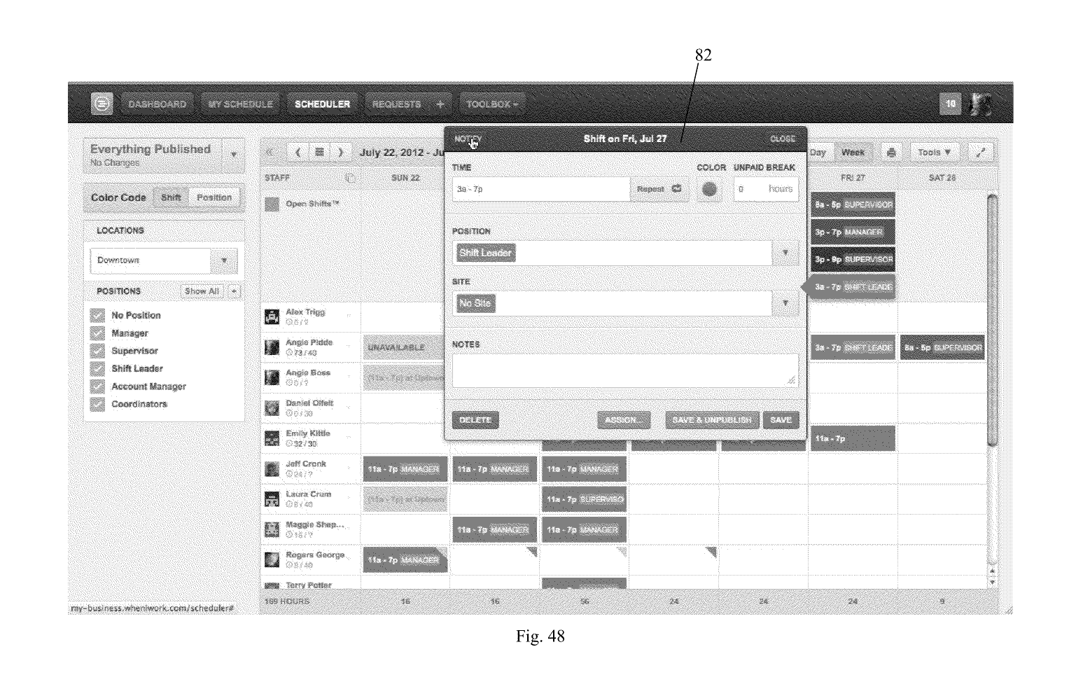

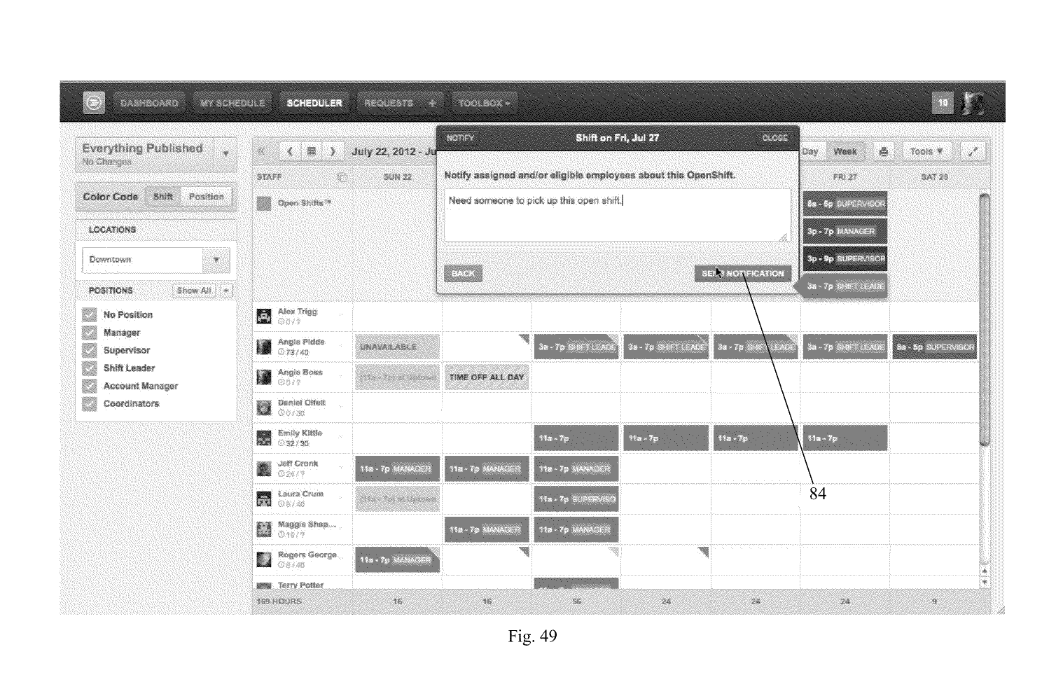

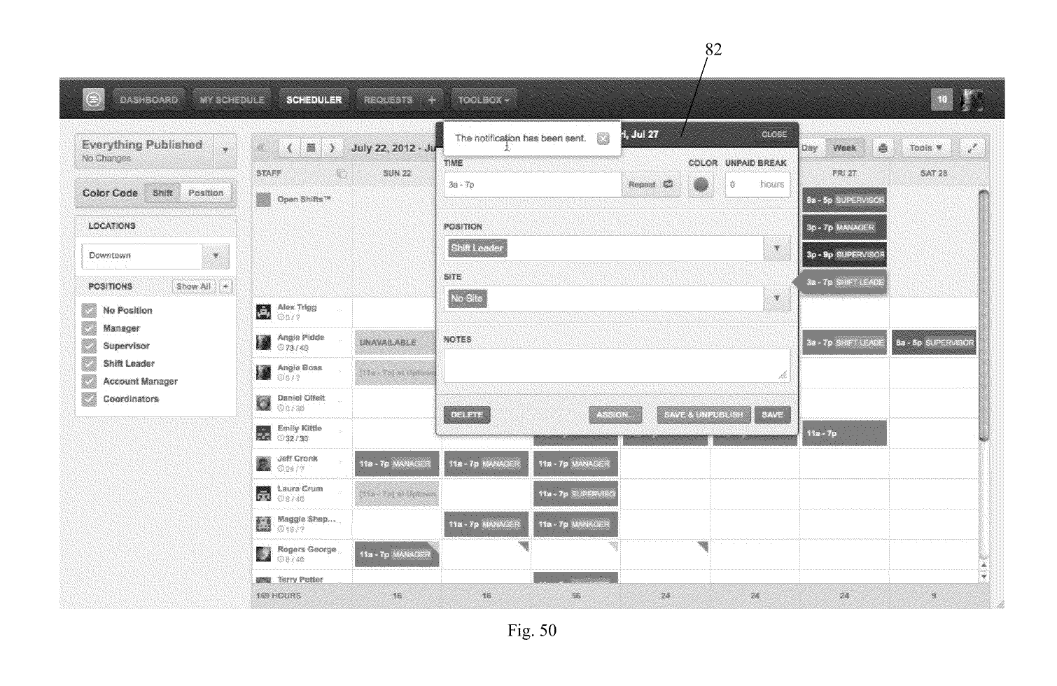

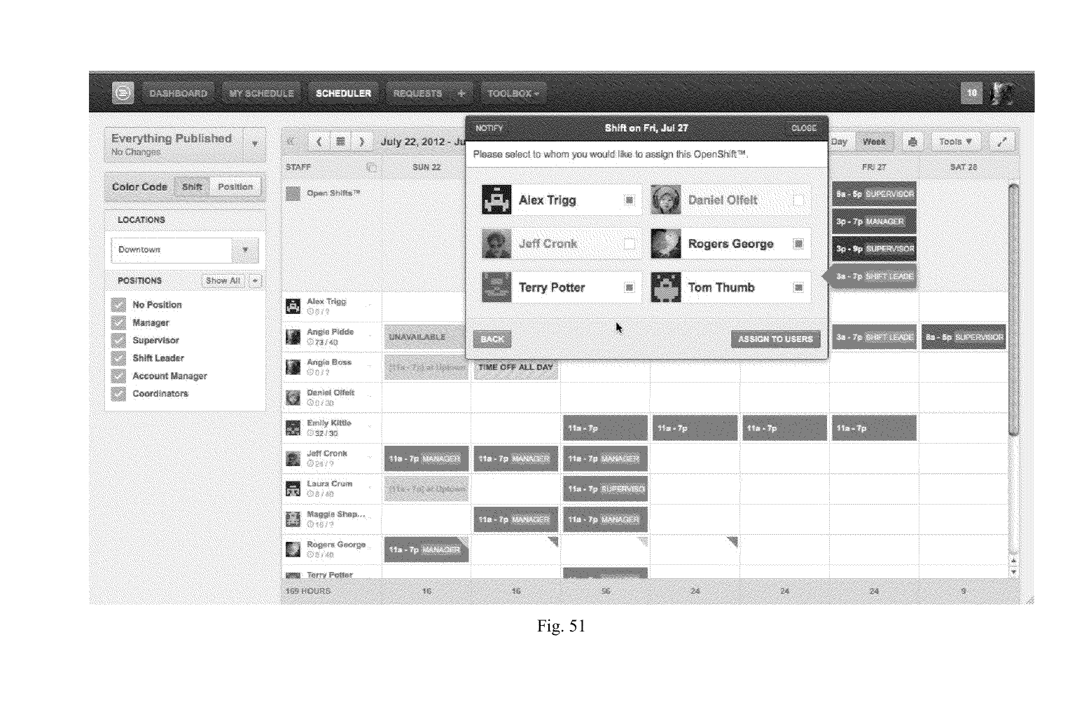

A personalized note can be added by the employer in box 82, drawing additional attention to the shift such as shown in FIGS. 48 and 49. A message, such as “I need someone to pick up this open shift” can be entered, and sent by clicking “send notification” at 84 (FIGS. 49 and 50). Notification (i.e., email and/or text message) can be sent to the selected employees, who can respond through the website, their mobile device (e.g., Smart Phone or tablet) or via text message, indicating that they will take (i.e., “accept”) the shift or not. The program as above preferably processes any reply and notifies the employer.

Color Coding of Shifts

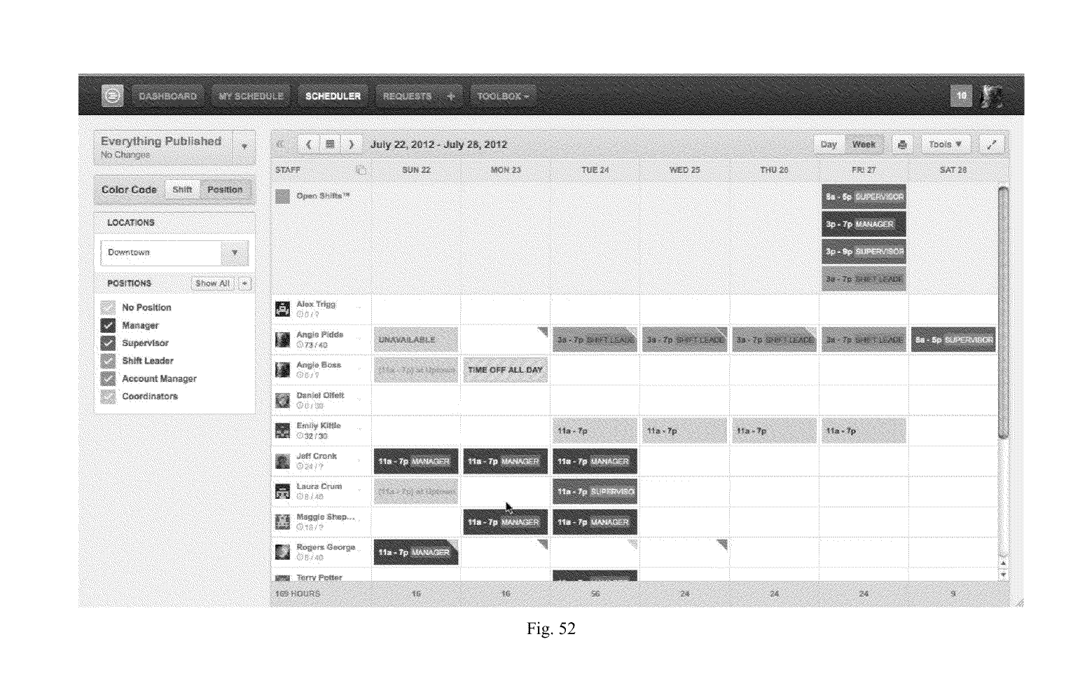

The previous figures have all shown the various shifts assigned with a color, for example, “shift leader” has been green, “supervisor” has been burnt orange, and “manager” has been teal. The program preferably allows the employer or user to modify the colors. See, for example, FIG. 52, which shows red shifts are manager shifts, gold shifts are shift leader shifts, etc.

Additionally, the program of the present invention preferably also allows the color of a shift to be different depending on whether the shift has been filled or accepted, or not.

The techniques of the present invention can also, as described herein, include providing a system, wherein the system includes distinct software modules, each of the distinct software modules being embodied on a tangible computer-readable recordable storage medium. All the modules (or any subset thereof) can be on the same medium, or each can be on a different medium, for example. The modules can include any or all of the components discussed herein. Method steps can then be carried out using the distinct software modules of the system executing on one or more hardware processors. Further, a computer program product can include a tangible computer-readable recordable storage medium with code adapted to be executed to carry out one or more method steps described herein, including the provision of the system with the distinct software modules.

Additionally, the techniques of the present invention can be implemented via a computer program product that can include computer useable program code that is stored in a computer readable storage medium in a data processing system, and wherein the computer useable program code can be downloaded over a network from a remote data processing system. Also, in one or more embodiments of the invention, the computer program product can include computer useable program code that is stored in a computer readable storage medium in a server data processing system, and wherein the computer useable program code can be downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. Such an implementation might employ, for example, a processor, memory, and an input/output interface formed, for example, by a display and a keyboard. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor, memory, and input/output interface such as display and keyboard can be interconnected, for example, via bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

As used herein, including the claims, a “server” includes a physical data processing system running a server program. It will be understood that such a physical server may or may not include a display and keyboard.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

Thus, embodiments of the NETWORK-BASED SCHEDULING APPLICATION are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A computer program product comprising a tangible computer readable recordable storage medium including computer useable program code for scheduling employees for a plurality of work shifts having different levels of qualifications, the program being a network-based mobile scheduling program, the program comprising:
computer useable program code for allowing an employer to set a work schedule; and
computer usable program code for automatically sending a notification to an employee via email, text message and/or mobile device regarding the schedule.

2. The computer program product of claim 1 further comprising computer useable program code for receiving a reply from the employee regarding the schedule.

3. The computer program product of claim 2 wherein the computer useable program code can receive a reply as sent by the employee via email, text message, and/or mobile device.

4. The computer program product of any of claim 2 further comprising computer useable program code for responding to the reply sent by the employee.

5. A computer program product comprising a tangible computer readable recordable storage medium including computer useable program code for scheduling employees for a plurality of work shifts having different levels of qualifications, the program being a network-based mobile scheduling program, the program comprising:
computer useable program code for an employer to input employee qualifications;
computer useable program code for an employer to input pre-qualifications for a shift; and
computer useable program code for an employer to create a schedule by assigning qualified employees to shift(s), the computer program product further comprising:
computer useable program code to not accept a non-qualified employee to a pre-qualified shift, and
computer useable program code to suggest a qualified employee to a pre-qualified shift.

6. The computer program product of claim 5 further comprising computer useable program code to notify the employee via mobile device, email and/or text message about their assigned shift(s).

7. The computer program product of claim 5 further comprising computer useable program code to allow the employee to view the assigned shift(s) on a mobile device.

8. The computer program product of claim 5 further having a shift scheduling feature that comprises:
computer useable program code for allowing an employee to decline or request a trade of an assigned shift via mobile device, email, and/or text message; and
computer useable program code for allowing an employer to override a trade request.

9. The computer program product of claim 5 having a shift scheduling feature that comprises:
computer useable program code for allowing the employer to notify the employee of an available shift, and
computer useable program code for allowing the employee to accept or reject the available shift.

10. The computer program product of claim 9 further comprising computer useable program code to advise the employer about the accepted or rejected available shift.

11. The computer program product of claim 5 further comprising computer useable program code to track total hours assigned to an employee in a schedule, and to indicate when a predetermined number of hours is exceeded.

12. The computer program product of claim 11 wherein the computer program further comprises computer useable program code for allowing an employer to input employee hourly wage, and if the predetermined number of hours is exceeded, calculates expenses for the exceeded hours.

13. A system for scheduling employees to a plurality of work shifts having different levels of qualifications, comprising:
a memory; and
at least one processor coupled to the memory and operative to:
allow an employer to identify employee qualifications;
allow an employer to identify pre-qualifications for a plurality of shifts;
allow and employer to create a schedule by assigning qualified employees to the shifts, wherein a non-qualified employee cannot be accepted within the schedule to a pre-qualified shift and further wherein qualified employees can be suggested to the employer for a pre-qualified shift.

14. The system of claim 13, wherein the processor and memory are further operative to notify the employee via mobile device, email and/or text message about their assigned shift(s).

15. The system of claim 13, wherein the processor and memory are further operative to to allow the employee to view the assigned shift(s) on a mobile device.

16. The system of claim 13, wherein the processor and memory are further operative to allow an employee to change an assigned shift by for allowing an employee to decline or request a trade of an assigned shift via mobile device, email, and/or text message.

17. The system of claim 13, wherein the processor and memory are further operative to allow an employee to make a trade request for an assigned shift and to also allow an employer to override a trade request as made by an employee.

18. The system of claim 13, wherein the processor and memory are further operative for allowing the employer to notify the employee of an available shift and for allowing the employee to accept or reject the available shift.

19. The system of claim 13, wherein the processor and memory are further operative to track total hours assigned to an employee in a schedule, and to indicate when a predetermined number of hours is exceeded. and for allowing an employer to input employee hourly wage.

20. The system of claim 13, wherein the processor and memory are further operative for allowing an employer to input employee hourly wage, and if the predetermined number of hours is exceeded, calculates expenses for the exceeded hours.
